(19) United States
(12) Patent Application Publication
(10) Pub. No.: US 2019/0311328 A1
(43) Pub. Date: Oct. 10, 2019

(54) Method and Apparatus for Project Management

(71) Applicants: Mitchell GERMAN, Lincroft, NJ (US); Gary SHEEHAN, Malvern, PA (US)

(72) Inventors: Mitchell GERMAN, Lincroft, NJ (US); Gary SHEEHAN, Malvern, PA (US)

(21) Appl. No.: 16/308,047

(22) PCT Filed: Jun. 9, 2017
(86) PCT No.: PCT/US2017/036886

§ 371 Date: Dec. 7, 2018

Related U.S. Application Data
(60) Provisional application No. 62/348,070, filed on Jun. 9, 2016.

(51) Int. Cl. G06Q 10/10; G06F 16/16; G06F 16/176; G06F 16/13

(52) U.S. Cl. CPC G06Q 10/101; G06Q 10/103; G06F 16/13; G06F 16/176; G06F 16/168

(57) ABSTRACT

A computer system and method for project management provides an integrated platform for collaboration, monitoring progress and completion of project related tasks, and creation, modification, and management of project related application files across multiple application programs.

### BACKGROUND OF THE INVENTION

1. Field of the Invention

The present invention relates generally to a method and apparatus for project management.

2. Background Art

Over the few recent decades, computer systems running application programs have become indispensable tools for the progress and completion of projects in nearly all fields of endeavor. However, application programs are geared toward accomplishing specific tasks like creating the design of a machine part, or creating a document, or creating a video presentation, but they are deficient in guiding the progress of the task to a final desired result and in guiding the breaking up of a task into more easily achievable steps. Also, the application programs do not allow the progress of the project and the activities of the participants to be tracked to ensure that the project is on track for finishing on time.

When multiple participants must work on an application file, the participants will email updated versions of the file incorporating their changes to each other, which the recipient downloads and makes further changes to the application file locally. The result is that the participants will each be working on different versions of the application file with each version being at a different stage of completion. Coordinating the creation of a final version of the application file incorporating all the changes and ensuring that all such changes meet the approval of the participants becomes a nightmare fraught with the danger that some important change will be left out or an unapproved change will be left in, which could result in delays and cost overruns and embarrassment to the participants.

The problem is multiplied when multiple application programs are required for the completion of the project. Participants must sift through the files on their computer to find the files related to the project and perhaps review each file to ensure that they are using the latest version. These problems exist even in solo projects, especially where the participant is concurrently working on several projects that use the same application programs. Accordingly, serious technical problems exist that encumber the efficacious use of computers and computer application programs for completing myriad types of projects in nearly all fields, and the need persists for solutions to these technical problems.

### SUMMARY OF THE INVENTION

The present invention solves the aforementioned problems by providing an integrated platform for maintaining all project related application files in one logical location and organized according to project, allowing participants access to the application files for doing their work, monitoring project related activities and progress, ensuring project access by authorized participants only, and facilitating coordination, communication, file sharing, and sharing of ideas among participants.

Accordingly, it is an aspect of the present invention to provide a method for managing projects carried out by one or more participants using a computer system and at least one application program, the computer system including at least one display, at least one processor, input means, and data storage means, the method comprising the steps of:

providing a control program for performing the method in the data storage means;

maintaining for each participant an individual project space in the data storage means, wherein the participant's project space includes data identifying projects that the participant is authorized to participate in and project files or links to project files each corresponding to a respective one of the identified projects, wherein each project file includes project data for the corresponding project;

presenting a saved projects screen to the participant using the display when the control program is prompted to present saved projects by the participant using the input means, wherein the saved projects screen presents an array or list of saved project objects each corresponding to and uniquely identifying a respective one of the projects for which the participant is an authorized participant;

presenting a project screen to the participant using the display when the control program is prompted by the participant to allow access to the project file for a specific project, selected from the projects for which a saved project object appears on the saved projects screen, identified to the control program by the participant using the input means and the corresponding saved project object on the saved projects screen or when the control program is prompted by the participant to create a new project and a corresponding new project file, which is a logical manifestation of the new project, wherein the project screen being presented constitutes an open project screen and the corresponding project file and project constitute an open project file and an open project, respectively;

providing within the project screen one or more tabs each corresponding to a user defined project element associated with the project, wherein one of the tabs is highlighted either by default or as selected by the participant;

providing within the project screen one or more sub-tabs each corresponding to a user defined sub-element associated with the project element corresponding to the highlighted tab, wherein one of the sub-tabs is highlighted either by default or as selected by the participant;

providing within the project screen one or more title bubbles each corresponding to a user defined subject associated with the sub-element corresponding to the highlighted sub-tab;

providing within each title bubble an add title bubble button that can be actuated by the participant using the input means to add a new title bubble to the project screen;

providing within each title bubble an add note button that can be actuated by the participant to add and associate a note bubble on the project screen with the title bubble corresponding to the actuated add note button, wherein each note bubble has a text field for entering and displaying text;

maintaining a database of application files that are recognizable and modifiable by the application program and that are associated with the open project as indicated by the database being maintained within the open project file or being identified within the project file;

launching the application program in response to an input from the participant under the direction of the control program and opening a new or saved application file associated with the open project for modification by the participant; and

adding the new application file, if any, to the database of application files that are associated with the open project.

It is another aspect of the present invention to provide a method incorporating the previously described aspect of the present invention, wherein a respective database of associated application files is maintained for each project of each participant.

It is still another aspect of the present invention to provide a method incorporating any one or any combination of the previously described aspects of the present invention, wherein the database of associated application files contains file names and paths for each of the associated application files.

It is yet another aspect of the present invention to provide a method incorporating any one or any combination of the previously described aspects of the present invention, wherein the method further comprises the step of displaying a view tab in addition to the one or more tabs corresponding to project elements, wherein the view tab can be selected to choose between one or more ways to display the tab, sub-tab, title bubble, and note bubble data.

It is yet another aspect of the present invention to provide a method incorporating any one or any combination of the previously described aspects of the present invention, wherein the method further comprises the steps of:

displaying within each note bubble an add sub-note button that can be actuated by the participant to add and associate a sub-note bubble with the note bubble corresponding to the actuated add sub-note button, wherein each sub-note bubble has a text field for entering and displaying text; and

displaying the sub-note bubble on the project screen.

It is yet another aspect of the present invention to provide a method incorporating any one or any combination of the previously described aspects of the present invention, wherein the at least one application program comprises a plurality of application programs needed to complete the open project, the method further comprising the steps of:

providing an application program space on the project screen;

displaying a plurality of icons in the application program space, each icon corresponding to a respective one of the plurality of application programs; and

displaying an application file window showing a list of application files of a type corresponding to a selected one of the plurality of application programs and associated with the open project, wherein the selected one of the plurality of application programs is selected by the participant by selecting the corresponding application program icon.

It is yet another aspect of the present invention to provide a method incorporating any one or any combination of the previously described aspects of the present invention, wherein the method further comprises the steps of displaying an add application file button in the application file window, which can be selected by the participant to open a new application file of the type corresponding to the selected one of the plurality of application programs, wherein the new application file will be added to the list of application files displayed in the application file window once the new application file is saved.

It is yet another aspect of the present invention to provide a method incorporating any one or any combination of the previously described aspects of the present invention, wherein the new application file is also added to the database of application files that are associated with the open project once the new application file is saved and wherein the database of application files is structured so as to allow identification of the application program corresponding to each application file in the database of application files.

It is yet another aspect of the present invention to provide a method incorporating any one or any combination of the previously described aspects of the present invention, wherein at least one selected field within one of the application files can be linked with a respective note bubble such that when corresponding data in one of the at least one selected field within one of the application files and the respective note bubble is modified then the corresponding data in the other one of the at least one selected field within one of the application files and the respective note bubble is also modified in the same way.

It is yet another aspect of the present invention to provide a method incorporating any one or any combination of the previously described aspects of the present invention, wherein a selected field within one of the application files can be linked with a respective field in another application file and with a respective note bubble such that when corresponding data in one of these is modified then the corresponding data in all the others are also modified in the same way.

It is yet another aspect of the present invention to provide a method incorporating any one or any combination of the previously described aspects of the present invention, wherein the method further comprises the steps of displaying an add tab button on the project screen, which can be selected by the participant to add a new tab to the one or more tabs corresponding to project elements on the project screen.

It is yet another aspect of the present invention to provide a method incorporating any one or any combination of the previously described aspects of the present invention, wherein the method further comprises the steps of displaying an add sub-tab button on the project screen, which can be selected by the participant to add a new sub-tab to the one or more sub-tabs corresponding to the highlighted tab on the project screen.

It is yet another aspect of the present invention to provide a method incorporating any one or any combination of the previously described aspects of the present invention, wherein the participant can edit the label of a tab corresponding to a project element so that the label of the tab is indicative of the corresponding project element, wherein the participant can edit the label of a sub-tab corresponding to a sub-element so that the label of the sub-tab is indicative of the corresponding sub-element, and wherein the participant can edit the label of a title bubble so that the label of the title bubble is indicative of the corresponding subject.

It is yet another aspect of the present invention to provide a method incorporating any one or any combination of the previously described aspects of the present invention, wherein the at least one application program is a word processing program, wherein the project is directed to the preparation of a project document, the method further comprising the steps of:

displaying a view tab in addition to the one or more tabs corresponding to project elements, wherein the view tab can be selected to choose between one or more ways to display the tab, sub-tab, title bubble, and note bubble data comprising at least an outline mode wherein an outline of the tab, sub-tab, title bubble, and note bubble data is displayed on the project screen in place of the sub-tabs, title bubbles, and note bubbles and a document mode wherein the project document is displayed on the project screen in place of the sub-tabs, title bubbles, and note bubbles.

It is yet another aspect of the present invention to provide a method incorporating any one or any combination of the previously described aspects of the present invention, wherein a portion of the text in the project document can be linked to a selected note bubble.

It is yet another aspect of the present invention to provide a method incorporating any one or any combination of the previously described aspects of the present invention, wherein there are a plurality of participants and the participants can be individually assigned a status selected from administrator, sub-administrator, and user, wherein the administrator may designate one or more sub-administrators, wherein user's access to the software is controlled by the grant of licenses, and wherein the administrator has the authority to assign licenses to users and to designate blocks of licenses to be assigned to other end users by a sub-administrator chosen by the administrator.

It is yet another aspect of the present invention to provide a method incorporating any one or any combination of the previously described aspects of the present invention, wherein the method further comprises the step of displaying a dashboard from which the administrator or sub-administrators can monitor the activities of other users and the progress of projects.

It is yet another aspect of the present invention to provide a method incorporating any one or any combination of the previously described aspects of the present invention, wherein there are a plurality of participants and different participants have different privilege levels and have access to different subsets of projects, application programs, application files, tabs, sub-tabs, title bubbles, note bubbles, sub-note bubbles, and related actions or program features in accordance with their privilege level.

It is yet another aspect of the present invention to provide a method incorporating any one or any combination of the previously described aspects of the present invention, wherein the method further comprises the steps of:

monitoring the progress of the open project; and

generating a progress report showing which project related tasks have been completed and which project related tasks have yet to be completed.

It is yet another aspect of the present invention to provide a computer system incorporating any one or any combination of the previously described aspects of the present invention, wherein the computer system includes at least one display, at least one processor, input means, and data storage means.

It is yet another aspect of the present invention to provide a computer system incorporating any one or any combination of the previously described aspects of the present invention, wherein the computer system is a networked computer system comprising:

a plurality of client computer systems each comprising a client computer display, a client computer processor, client computer input means, and client computer data storage means; and

a server communicating with the plurality of client computer systems over a network, the server comprising at least a server computer processor and server computer data storage means, wherein the control program is at least stored in the server computer data storage means.

These and other advantages of the present invention will be apparent from the following description.

### BRIEF DESCRIPTION OF THE DRAWINGS

FIG. 1 is a functional block diagram illustrating one possible computer system for use with the present invention.

FIG. 2 is a block diagram illustrating a networked computer system for use with the present invention.

FIG. 3 illustrates the saved projects screen of the method of the present invention.

FIG. 4 illustrates the open project screen of the method of the present invention and shows Tabs, Sub-tabs, Title Bubble, Note Bubbles and Sub-note Bubbles.

FIG. 5 illustrates the capability to add more project elements or screen objects, such as Tabs, Sub-tabs, Title Bubble, Note Bubbles and Sub-note Bubbles.

FIG. 6 illustrates the capability to attach media, audio and video to a bubble.

FIG. 7 illustrates the capability to view, listen to and interact with all types of media inside the program.

FIG. 8 illustrates the capability to move ALL elements anywhere else in the project.

FIG. 9 illustrates the capability to generate an instant outline of all the tabs, sub-tabs, title bubbles, and note bubbles in order.

FIG. 10 illustrates the capability to invite other users to collaborate in projects managed using the software in accordance with the present invention.

FIGS. 11-13 illustrate the capability to allow collaborators to see only some, or all of the project that is managed using the software according to the present invention.

FIG. 14 illustrates the capability for users to change data in the outline and the data in the corresponding source bubble changes automatically in the same way and vice-versa.

FIG. 15 illustrates the capability to link Title Bubble and Note Bubble data to a document such that changing the Title and Note Bubble data changes the document.

FIG. 16 illustrates the capability to link Title and Note Bubble data to multiple documents.

FIG. 17 illustrates the capability to have multiple types of documents or application files (e.g. for Word, Excel, Power Point, Custom, etc.) embedded within the same project managed using the software according to the present invention.

FIG. 18 illustrates the capability to permit or control specific collaborating participants to access, edit and/or “see” certain shared parts of a document or project.

FIG. 19 illustrates the capability to customize Title Bubbles for specific uses via drop down menus.

FIG. 20 illustrates the capability to customize Note Bubbles for specific uses via drop down menus.

FIG. 21 illustrates the capability to organize Title and Note Bubbles by Sub Tabs, which can be customized for specific uses via drop down menus.

FIG. 22 illustrates the capability to show the history of creation and revisions of Title and Note Bubbles including the person making the changes and the date/time stamp.

FIG. 23 illustrates the capability to export Tabs, Sub Tabs, Title Bubbles and Note Bubbles to populate a specific customized template or document.

FIG. 24 illustrates the capability to use a pre-designed Template from a Web-based app store to create the architecture of Tabs, Sub Tabs, Title Bubbles and Note Bubbles associated with that Template.

FIG. 25 illustrates an “administrator” dashboard for keeping track of licenses and licensed users.

FIGS. 26 and 27 illustrate how the administrator can assign other users as “sub-administrators.”

FIG. 28 illustrates how the administrator can assign sub-administrators a designated number of licenses that the designated sub-administrator can then assign to other users of the present invention.

FIG. 29 illustrates how both the administrator and sub-administrators can assign licenses and add users into the software based on the total number of license that are available to them.

FIG. 30 illustrates how, from the same screen, an administrator can see every user that has been added.

FIG. 31 illustrates how the administrator can assign users directly for sub-administrators, eliminating the need for the sub-administrator to add their own users.

FIGS. 32 and 33 illustrate how administrators, sub-administrators and other types of users have different roles.

FIG. 34 illustrates how the software automatically tracks progress of completed tasks in each individual project and reports it to all of the relevant users.

FIG. 35 illustrates how administrators and sub-administrators can see which projects have changed since they last accessed them.

FIG. 36 illustrates how, in the project screen, the various users can see relevant changes that apply to them.

### DETAILED DESCRIPTION OF THE INVENTION

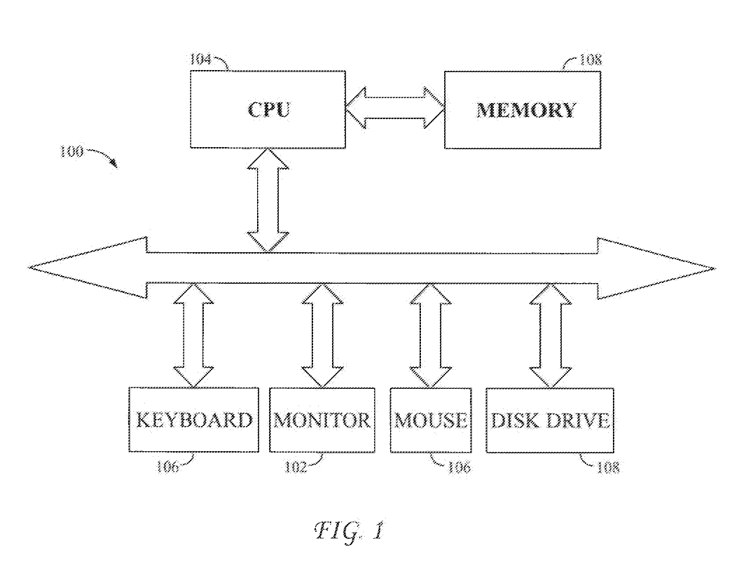

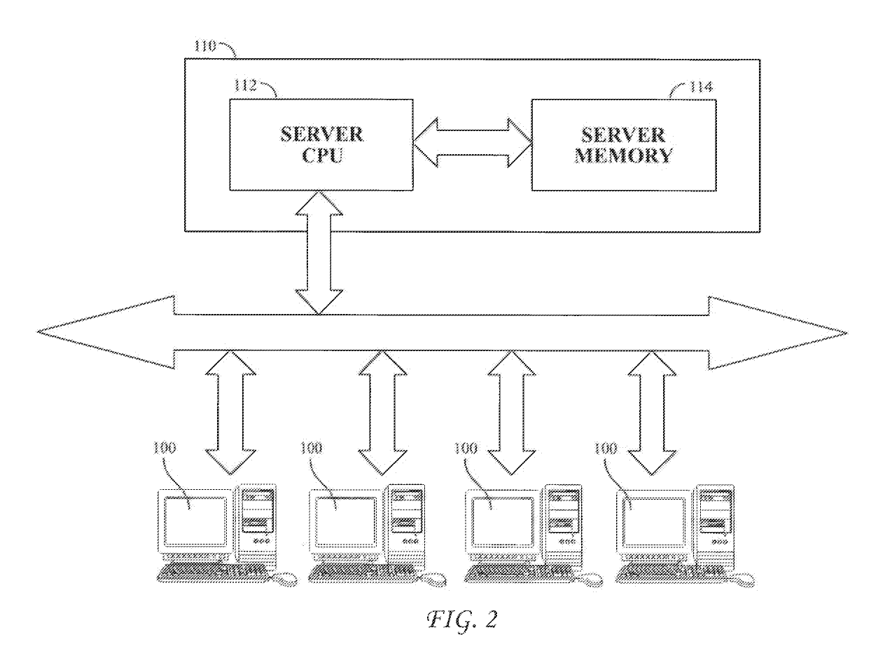

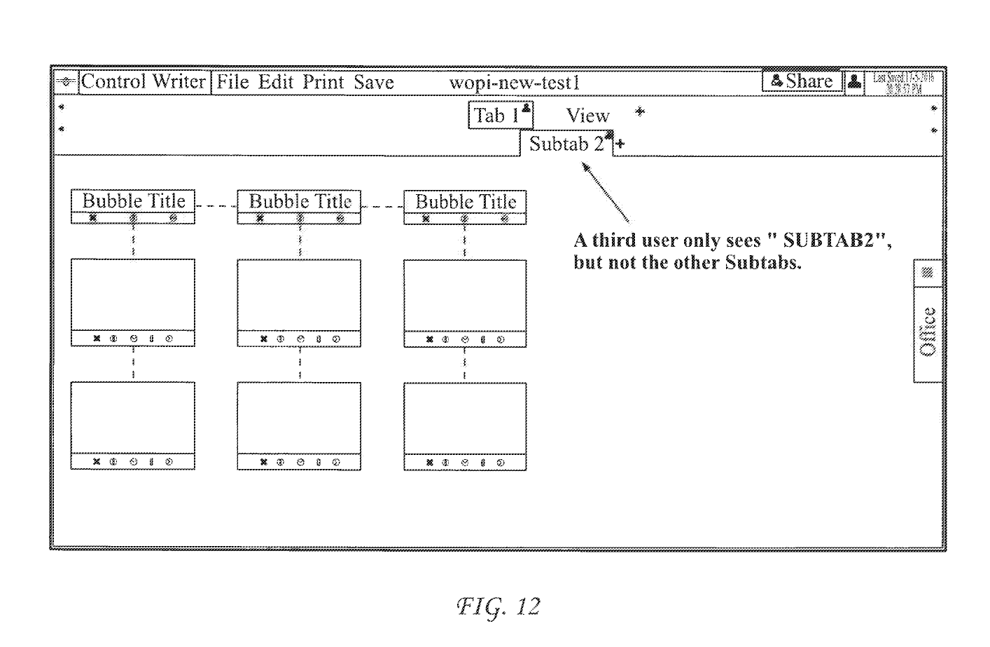

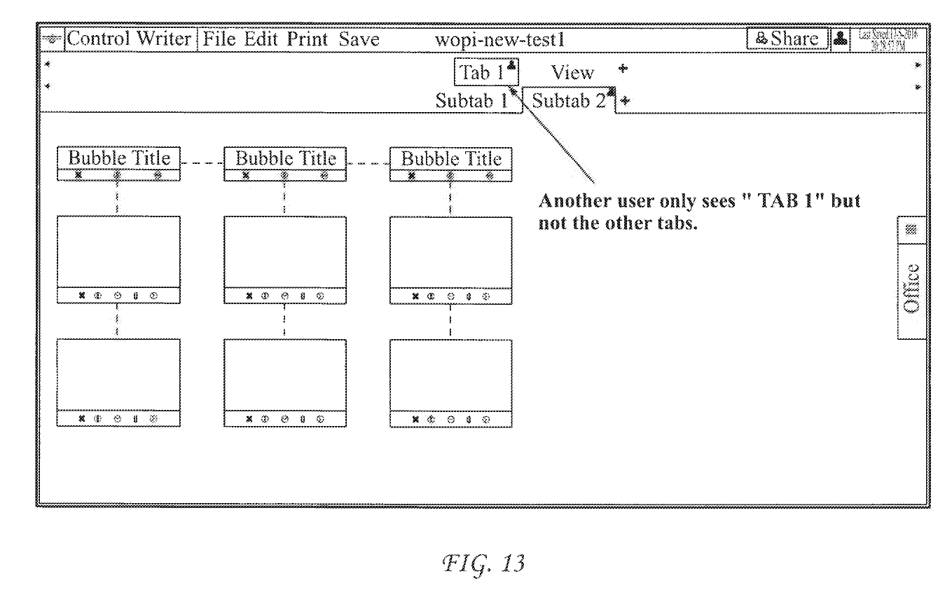

Referring to FIGS. 1-36, the present invention is directed to a system and method for project management that addresses the technical problems that have heretofore hampered the management of projects involving computer-based performance of project tasks.

The present invention can be implemented using a computer system 100 that includes at least one display 102, at least one processor 104, input means 106, and data storage means 108. The terms computer system as used herein broadly designates computer systems that may include stand-alone computers, a system of dumb terminals connected to a multiuser computer system, personal computers, tablets, smart phones, PDAs, servers, or networks of these various devices including LANs, WANs, Enterprise networks, and the internet or worldwide web. Such networks may employ peer-to-peer or client-server architecture or any combination of these. A convenient platform for the present invention is the internet and a plurality of client computers with internet access.

A typical network type computer system for use with the present invention would be a networked computer system including a plurality of client computer systems and a server communicating with the plurality of client computer systems over a network. Each client computer system typically at least includes a client computer display, a client computer processor, client computer input means, and client computer data storage means. Input means is used broadly herein and includes keyboards, mice, touch pads, touch screens, pens, trackballs, and typically combinations of these.

The server 110 includes at least a server computer processor 112 and server computer data storage means 114. At least the control program, i.e. the executable code for the software of the present invention, is stored in the server computer data storage means. The control program may be downloaded to the client computer for execution or may be executed on the server or both. Alternatively, a licensed version of the software of the present invention may be installed on a long term basis on the client computer, other types of networked computer, or on a stand-alone computer depending on the nature of the project and the level of collaboration required.

Data storage means as used herein broadly refers to any type of data storage device or memory that can store electronic data such that the data can be accessible to the computer system processor. Examples, of data storage means include, without limitation, semiconductor memory directly addressable by the processor and mass storage devices such as hard disks, floppy disks, CDs, DVDs, Blu-ray disks, flash drives and flash memory cards.

The method of the present invention requires the use of a computer system. The method of the present invention is a method for managing projects carried out by one or more participants using a computer system and at least one application program. The computer system typically includes at least one display, at least one processor, input means, and data storage means as previously stated. The method according to the present invention some or all of the steps described below.

A control program for performing the method according to the present invention would preferably be stored in a data storage means in the computer system being used to implement the method.

An individual project space would be maintained in the data storage means for each participant in the project. The participant's project space includes data identifying projects that the participant is authorized to participate in and project files or links to project files each corresponding to a respective one of the identified projects. Each project file includes project data for the corresponding project. These includes identities of participants, the structure of project objects such as the structure of tabs, sub-tabs, title bubbles, note bubbles, and sub-note bubbles, data regarding the nature of what is represented by each object including identifying information and labels of each object; at least identification and location information for application programs and application files associated with the project; participants access rights or permissions with respect to each object; data contained in each of the data fields within the objects; links between object data and application file data; participants assigned privilege levels; etc.

When a user initially invokes the program, the user is presented with a login screen providing for the usual user ID and password information. The next screen gives the user the opportunity to create a new project or to browse and select one of the number of existing saved projects in which the user is an authorized participant.

If the user elects to browse the saved projects, the user or participant is presented with a saved projects screen 116 using the display. The control program is prompted to present saved projects by the participant using the input means. The saved projects screen presents an array or list of saved project objects each corresponding to and uniquely identifying a respective one of the projects for which the participant is an authorized participant. The saved project objects can be an icon, usually combined with a literal or textual element, which uniquely represents the corresponding saved project. In the illustrated embodiment, each saved project object 118 is a blue rectangular field with the name of the project inside.

A project screen 120 is presented to the participant using the display when the control program is prompted by the participant to allow access to the project file for a specific project. The specific project may be selected from the projects for which a saved project object appears on the saved projects screen, identified to the control program by the participant using the input means and the corresponding saved project object on the saved projects screen or when the control program is prompted by the participant to create a new project and a corresponding new project file. The new project file is the logical manifestation of the new project. The project screen 120 being presented constitutes an open project screen and the corresponding project file and project constitute an open project file and an open project, respectively. The terms selected project, open project, current project, the project currently being worked on, selected project file, open project file, current project file, and the project file currently being worked on are used interchangeably herein unless otherwise specified.

One or more tabs 122 each corresponding to a user defined project element associated with the selected or current project are provided within the project screen 120. One of the tabs 122 is highlighted either by default or as selected by the participant. As an example, a project element may be a date range with each tab being a different date range in a sequence. Project related activities for each date range would then be organized under the tab for that date range. As another example, each tab may correspond to a part of a larger machine that is being built, with a different collaborator being responsible for the design of the part corresponding to a different tab. As yet another example, each tab may correspond to a project task such as question of interest, background research, formulate hypothesis, experimental design, experimental results, and data analysis and conclusions for a scientific research project. As yet another example, each tab 122 may correspond to a collaborator with the tasks assigned to that collaborator organized under the corresponding tab.

One or more sub-tabs 124 are provided within the project screen 120. Each of the one or more sub-tabs corresponds to a user defined sub-element associated with the project element corresponding to the highlighted tab 122. One of the sub-tabs 124 is highlighted either by default or as selected by the participant. A sub-element may, for example be the material for the machine part when the tab 122 corresponds to the machine part. As another example, the sub-element corresponding to the sub-tab 124 may be a collaborator's name when the tab 122 corresponds to a time period in the life of the project.

One or more title bubbles 126 are provided within the project screen. The one or more title bubbles each correspond to a user defined subject associated with the sub-element corresponding to the highlighted sub-tab 124. As an example, one title bubble 126 may refer to, and hence have as its subject, a task assigned to the collaborator or participant when the sub-element corresponding to the highlighted sub-tab 124 is the collaborator's name and the highlighted tab 122 corresponds to a time period in the life of the project.

An add title bubble button 128 is provided within each title bubble 126. The add title bubble button 128 can be actuated by the participant using the input means to add a new title bubble to the project screen under the highlighted sub-tab. In the illustrated example, the add title bubble button 128 is in the form of a plus sign.

An add note button 130 is provided within each title bubble 126. The add note button 130 can be actuated by the participant to add and associate a note bubble 132 on the project screen with the title bubble 126 corresponding to the actuated add note button. Each note bubble 132 has a text field for entering and displaying text, which constitutes the note. In the illustrated example, the add note button 130 is in the form of a plus sign. The user can type text into the note bubble 132 using the input device. As an example, one note bubble 132 may contain a statement of the estimated cost of accomplishing the project task associated with the corresponding title bubble 126, which is a task assigned to the collaborator or participant when the sub-element corresponding to the highlighted sub-tab 124 is the collaborator's name and the highlighted tab 122 corresponds to a time period in the life of the project.

An add note button 152 is provided within each note bubble 132. The add note button 152 can be actuated by the participant to add and associate a note bubble 132 on the project screen with the preexisting note bubble 132 corresponding to the actuated add note button 152.

A database of application files that are recognizable and modifiable by the application program and that are associated with the open project is maintained by the system and the control program. The association between the database of application files and the open project would indicated by the database being maintained within the open project file or being identified within the open project file or there being links to the database or to the application files within the open project file. The application program can be a word processing program, a spreadsheet, a slide presentation program, a database program, a graphics, drawing, or illustration program, desktop publishing software, CAD/CAM software, animation or film editing software, or any other type of application program that may be useful in accomplishing tasks and goals within a project.

The application program can be launched from within the open project screen. The application program is launched in response to an input from the participant under the direction of the control program and a new application file or saved application file associated with the open project, as selected by the participant, is opened for modification and further work by the participant.

If a new application file is opened, then the new application file, or a link to it, is added to the database of application files that are associated with the open project when the new application file is first saved. A respective database of associated application files is maintained for each project of each participant. Unless otherwise specified, “database” is used herein to broadly refer to any kind of scheme, relying at least in part on the control program for its implementation, for associating an application file with its respective project and locating it for access as needed. In a preferred embodiment, the database of associated application files contains file names and paths for each of the associated application files.

A view tab 134 is displayed on the project screen in addition to the one or more tabs 122 corresponding to project elements. The view tab can be selected to choose between one or more ways to display the tab, sub-tab, title bubble, and note bubble data.

An add sub-note button 136 is displayed within each note bubble 132. The add sub-note button 136 can be actuated by the participant to add and associate a sub-note bubble 138 with the note bubble 132 corresponding to the actuated add sub-note button. Each sub-note bubble 138 has a text field for entering and displaying text. The participant can select the text field of the sub-note bubble and enter desired text into that text field using the input means 106. The sub-note bubble is displayed on the project screen. As an example, a sub-note bubble may include may include a note regarding the expected date for funding availability when the associated note bubble contains a statement about funding requirements for project task.

Typically, a plurality of application programs are needed to complete the open project. For example, the application programs Microsoft Word (word processor), Microsoft Excel (spread sheet), Microsoft Access (database), and Microsoft Powerpoint (slide presentation) may be required for the completion of a project. In the illustrated embodiment, an application program space is provided on the project screen 120. A plurality of icons 140 are displayed in the application program space. Each icon 140 corresponds to a respective one of the plurality of application programs. A participant can select an application program by selecting the corresponding icon 140 using the input means 106.

An application file window 142 showing a list of application files of a type corresponding to a selected one of the plurality of application programs and associated with the open project is displayed on the project screen 120. The selected one of the plurality of application programs is selected by the participant by selecting the corresponding application program icon 140.

An add application file button 144 is also displayed in the application file window 142, which can be selected by the participant to open a new application file of the type corresponding to the selected one of the plurality of application programs. The new application file will be added to the list of application files displayed in the application file window once the new application file is saved.

The new application file is also added to the database of application files that are associated with the open project once the new application file is saved. The database of application files is structured so as to allow identification of the application program corresponding to each application file in the database of application files.

At least one selected field within one of the application files can be linked with a respective note bubble such that when corresponding data in one of the selected field within the application file and the respective note bubble is modified, then the corresponding data in the other one of the selected field within the application file and the respective note bubble is also modified in the same way.

A selected field within one of the application files can also be linked with a respective field in another application file as well as with a respective note bubble such that when corresponding data in one of these is modified then the corresponding data in all the others are also modified in the same way.

Preferably, an add tab button 146 is displayed on the project screen 120, which can be selected by the participant using the input device 106 to add a new tab 122 to the one or more tabs 122 corresponding to project elements that are already on the project screen. Similarly, an add sub-tab button 148 is displayed on the project screen, which can be selected by the participant to add a new sub-tab 124 to the one or more sub-tabs 124 corresponding to the highlighted tab 122 that are already on the project screen 120.

The participant can edit the label of a tab 122 corresponding to a project element so that the label of the tab is indicative of the corresponding project element. The participant can edit the label of a sub-tab 124 corresponding to a sub-element so that the label of the sub-tab is indicative of the corresponding sub-element. Also, the participant can edit the label of a title bubble 126 so that the label of the title bubble is indicative of the corresponding subject. The selection and editing of the labels can be accomplished by using the input means 106.

Templates can be provided that tailor the structure of the tabs, sub-tabs, title bubbles, note bubbles, sub-note bubbles, the available selection of application programs, and the project screen 120 to projects in particular fields of endeavor. For example, one template may tailor the structure of the tabs, sub-tabs, title bubbles, note bubbles, sub-note bubbles, the available selection of application programs, and the project screen 120 to projects that are academic term papers. Another template may tailor the structure of the tabs, sub-tabs, title bubbles, note bubbles, sub-note bubbles, the available selection of application programs, and the project screen 120 to projects that are essays prepared to meet the requirements of and accompany applications for entrance to universities. In such cases, the at least one application program would be a word processing program, and the project would be directed to the preparation of a project document or more simply a document.

In such embodiments, the view tab 134 can be selected to choose between one or more ways to display the tab, sub-tab, title bubble, and note bubble data including at least an outline mode, where an outline of the tab, sub-tab, title bubble, and note bubble data is displayed on the project screen in place of the sub-tabs, title bubbles, and note bubbles, and a document mode, where the project document is displayed on the project screen in place of the sub-tabs, title bubbles, and note bubbles. In embodiments tailored for document preparation projects, portions of the text in the project document can be linked to selected respective note bubbles such that the notes can act as headings and sub-heading in the outline for the corresponding linked text in the document.

For projects where there are a plurality of participants, the system of the present invention allows the participants to be individually assigned a status selected from administrator, sub-administrator, and user. These statuses are not always mutually exclusive. The administrator may designate one or more sub-administrators. The user's access to the software is controlled by the grant of licenses. The administrator has the authority to assign licenses to users and to designate blocks of licenses to be assigned to other end users by a sub-administrator chosen by the administrator.

The system of the present invention is capable of displaying a dashboard 150 from which the administrator or sub-administrators can monitor the activities of other users and the progress of projects.

Where there is a plurality of participants, the system of the present invention is capable of assigning different privilege levels to different participants such that different participants have access to different subsets of projects, application programs, application files, tabs, sub-tabs, title bubbles, note bubbles, sub-note bubbles, and related actions or program features in accordance with their privilege level.

Embodiments of the system of the present invention are also capable of:

a) monitoring the progress of the open project; and

b) generating a progress report showing which project related tasks have been completed and which project related tasks have yet to be completed.

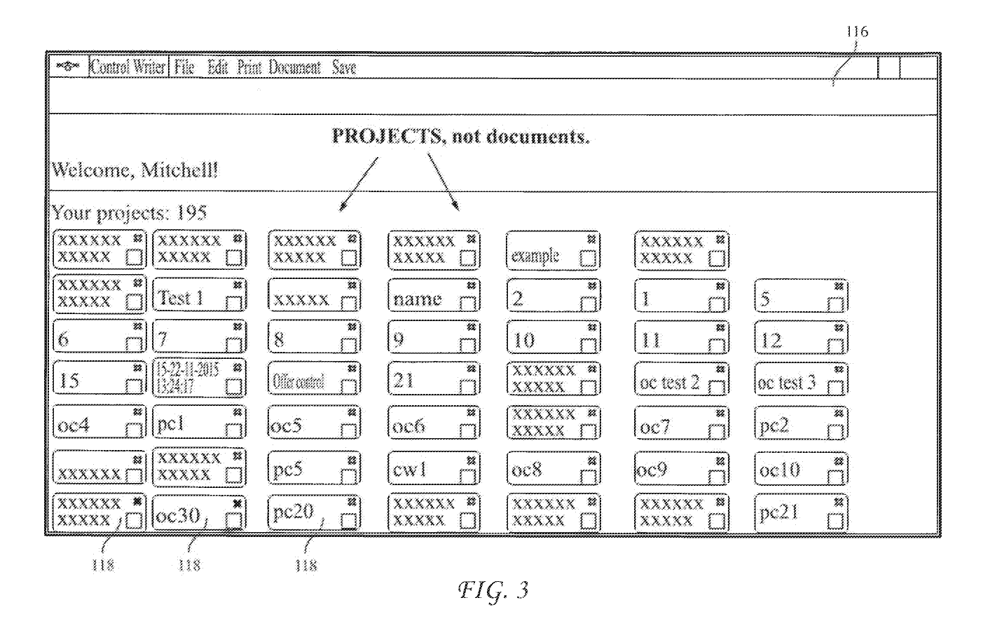

Referring to FIG. 3, the present invention provides the user or participant with the capability to organize data and information by PROJECT rather than documents.

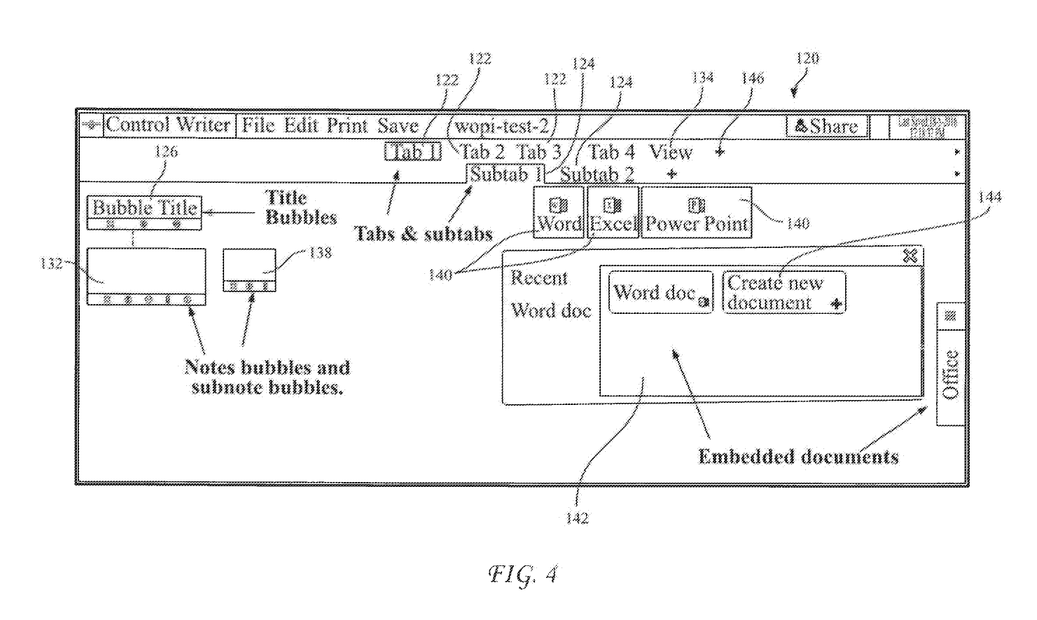

Referring to FIG. 4, the present invention provides the user or participant with the capability to organize project data by tabs, sub-tabs, bubbles, sub-bubbles and embedded documents or application files.

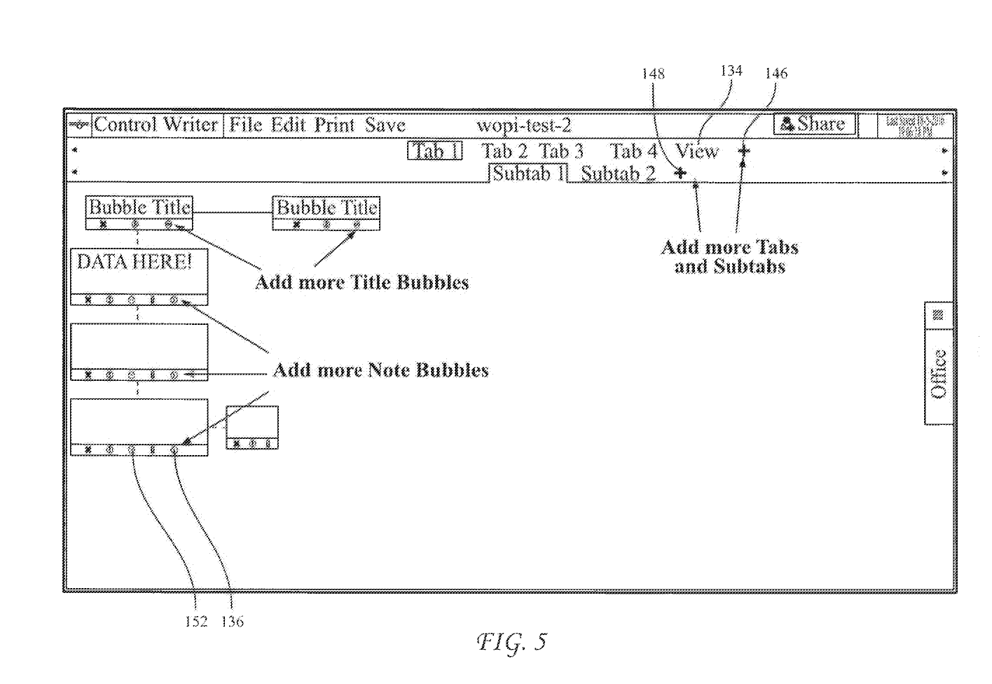

Referring to FIG. 5, the present invention provides users with the capability to add more project elements or screen objects, such as Tabs, Sub-tabs, Title Bubble, Note Bubbles and Sub-note Bubbles.

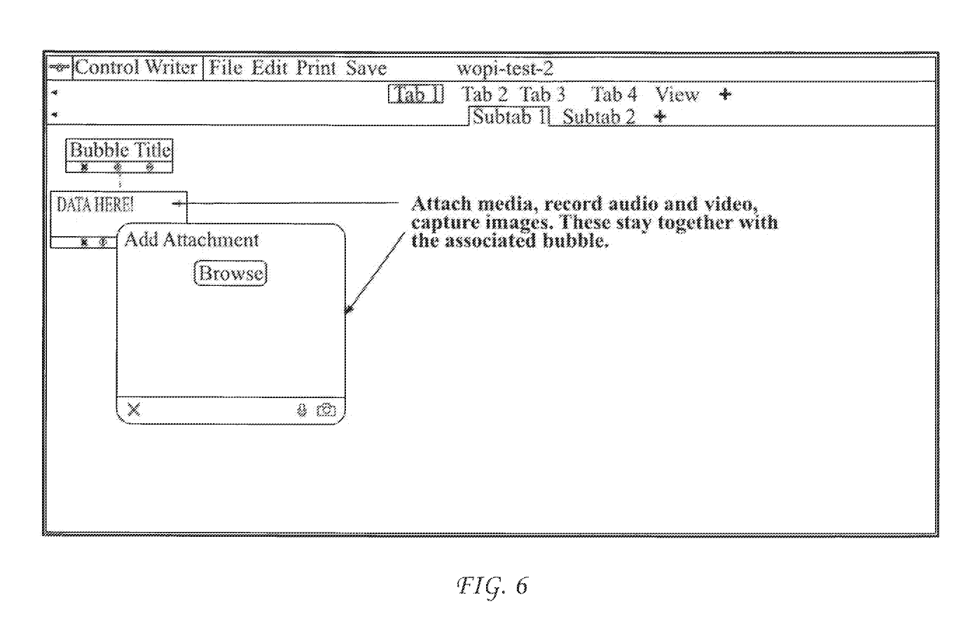

Referring to FIG. 6, the present invention provides users with the capability to attach media, audio and video to a bubble.

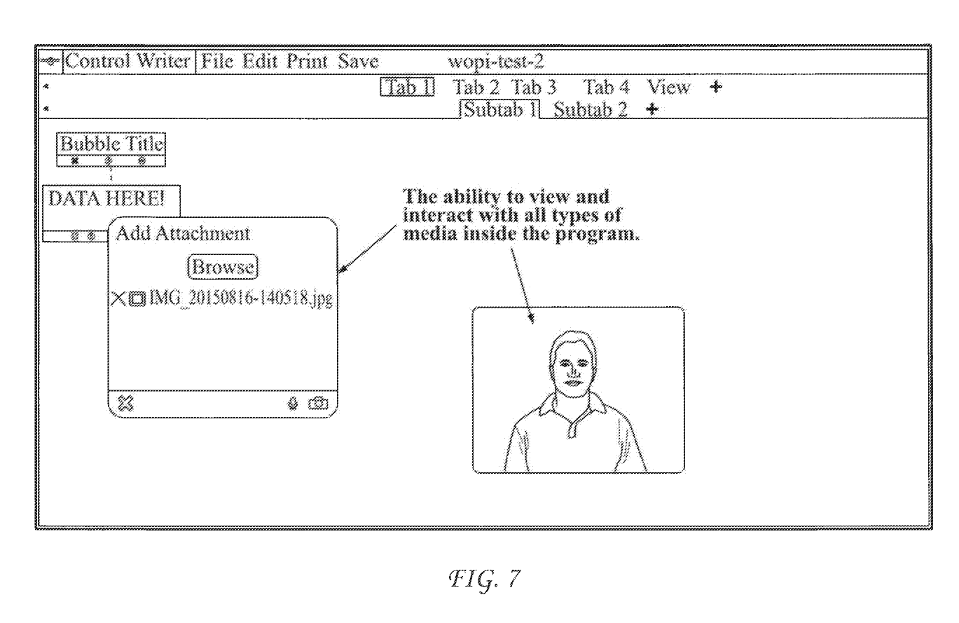

Referring to FIG. 7, the present invention provides users with the capability to view, listen to and interact with all types of media inside the program.

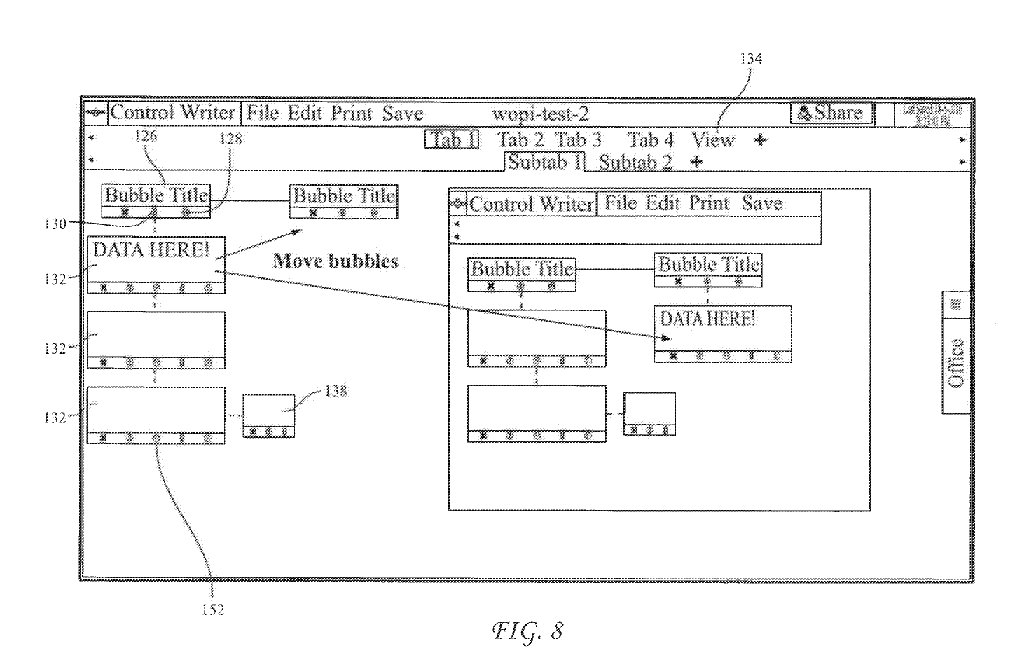

Referring to FIG. 8, the present invention provides users with the capability to move ALL elements anywhere else in the project.

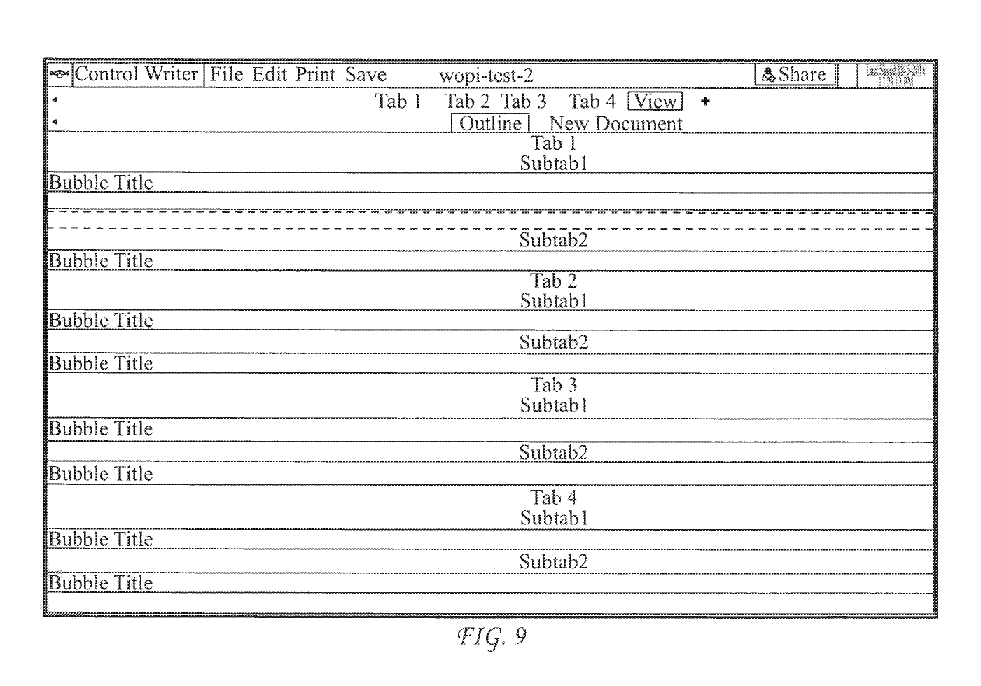

Referring to FIG. 9, the present invention provides users with the capability to generate an instant outline of all the tabs, sub-tabs, bubbles, and sub-bubbles in order.

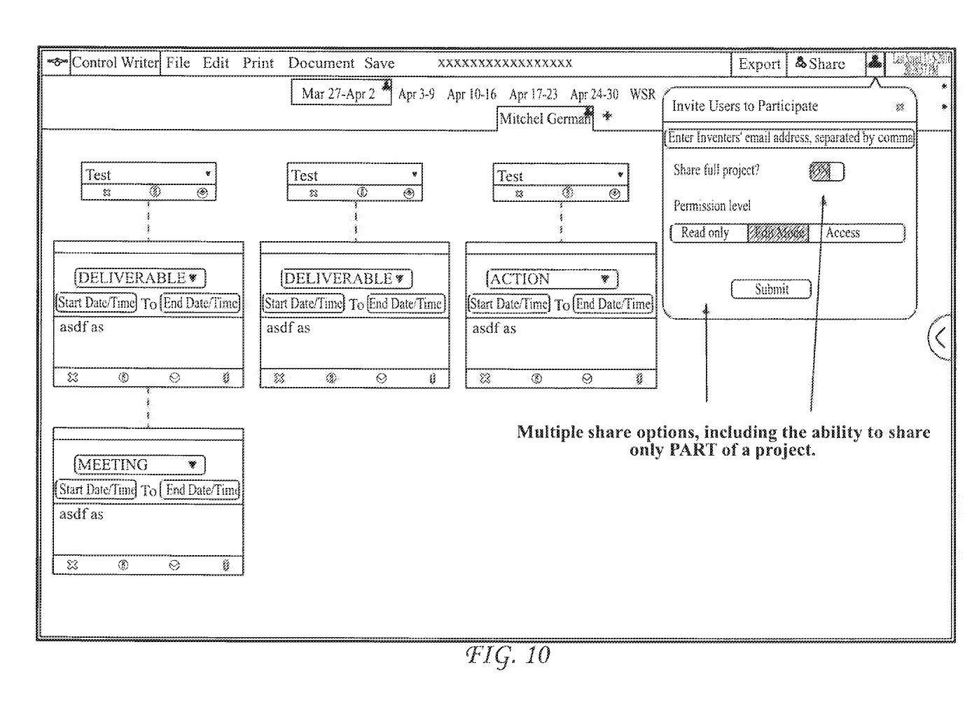

Referring to FIG. 10, the present invention provides users with the capability to invite other users to collaborate in projects managed using the software in accordance with the present invention.

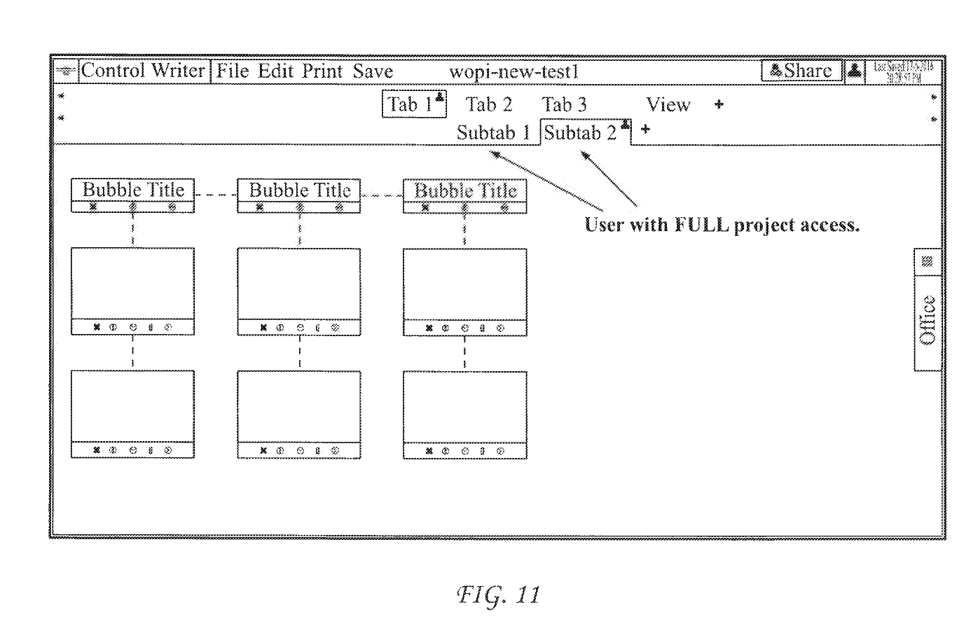

Referring to FIGS. 11-13, the present invention provides the capability to allow collaborators to see only some, or all of the project, managed using the software according to the present invention, depending upon their assigned privilege level or due to their being assigned as an authorized user to an object within the project.

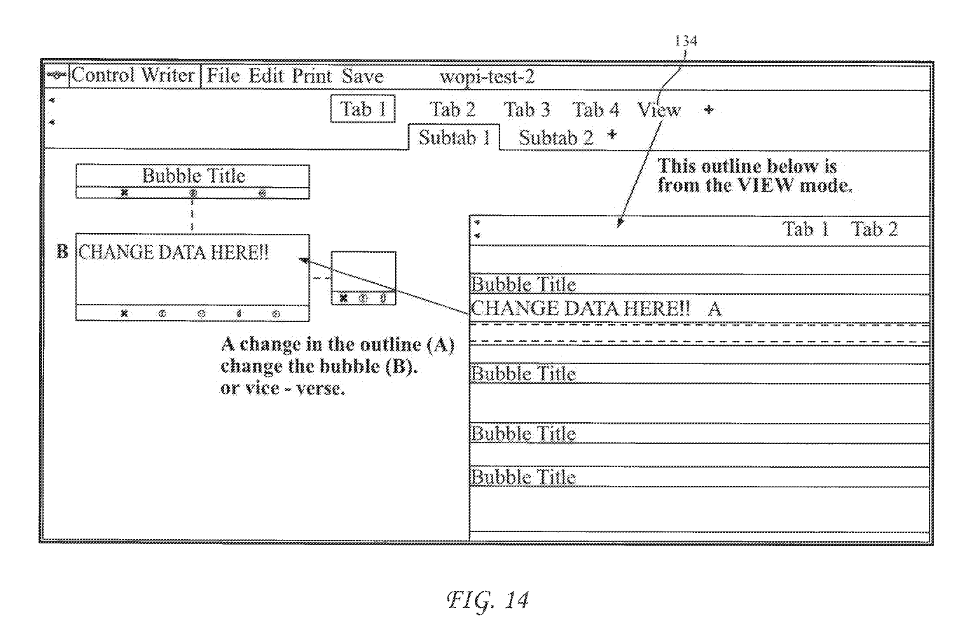

Referring to FIG. 14, the present invention provides the capability for users to change data in the outline and the data in the corresponding source bubble changes automatically in the same way and vice-versa.

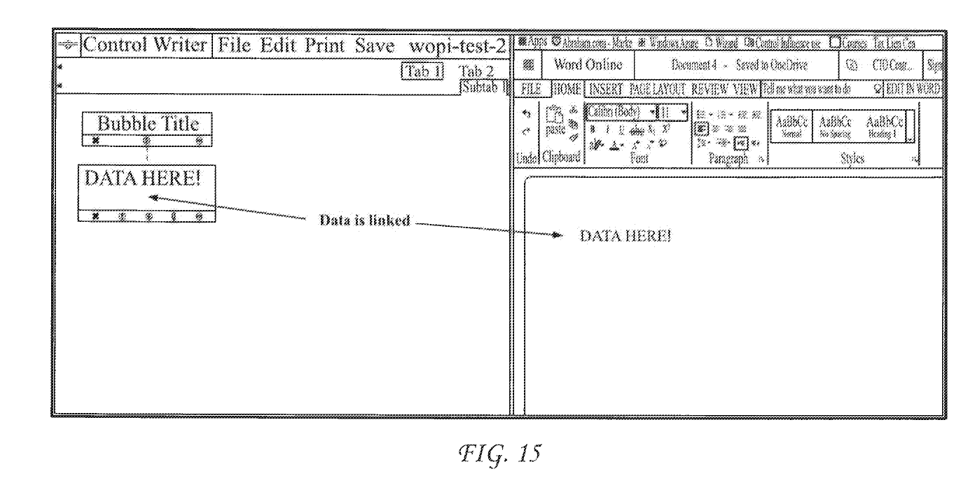

Referring to FIG. 15, the present invention provides the capability to link Title Bubble and Note Bubble data to a document such that changing the Title and Note Bubble data changes the document, and changing the relevant section of the document changes the associated Title Bubble and Note Bubble data.

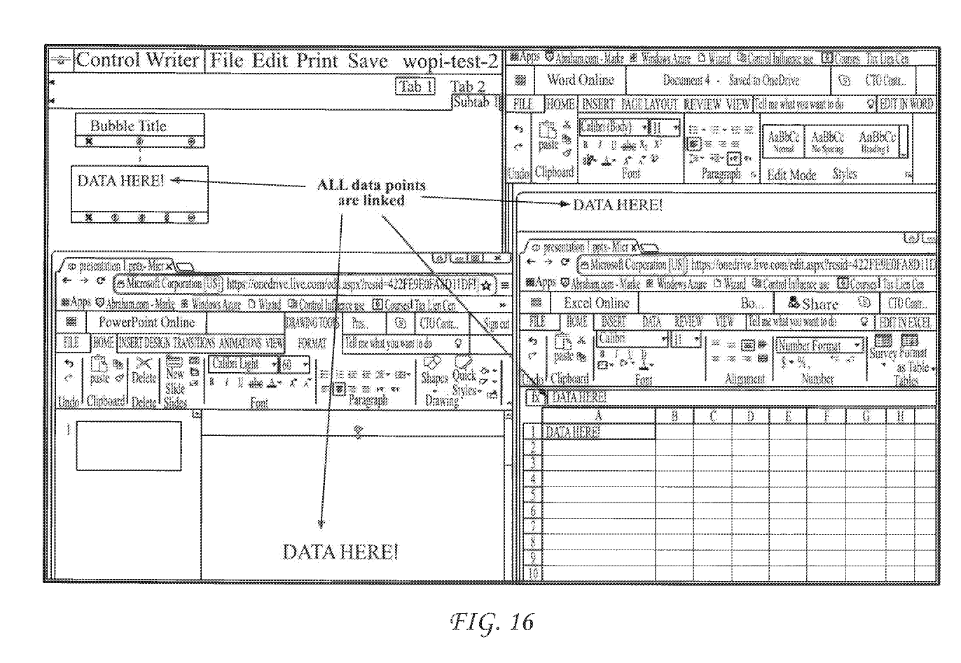

Referring to FIG. 16, the present invention provides the capability to link Title and Note Bubble data to multiple documents, such that revising the Title and Note Bubble information will revise the relevant sections in all related documents throughout a network or server.

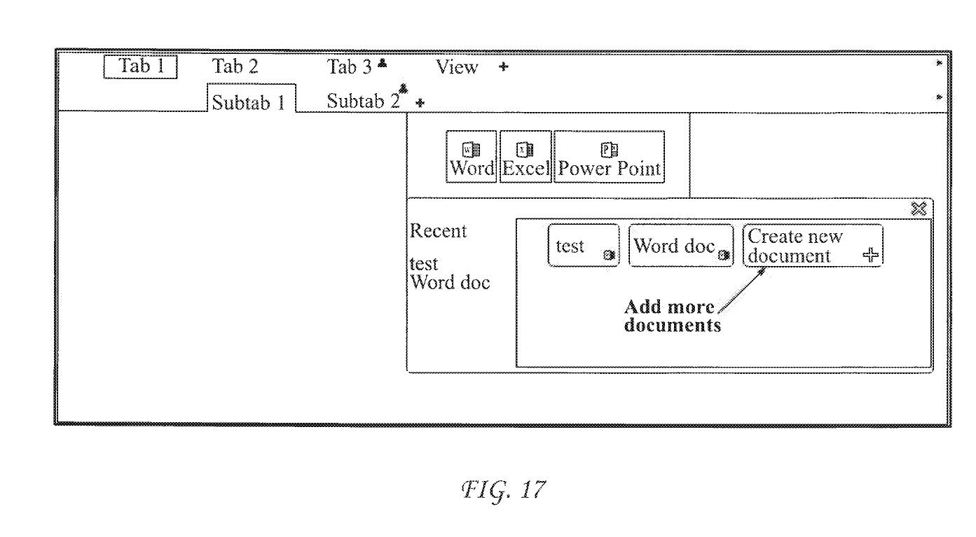

Referring to FIG. 17, the present invention provides the capability to have multiple types of documents or application files (e.g. for Word, Excel, Power Point, Custom, etc.) embedded within the same project managed using the software according to the present invention.

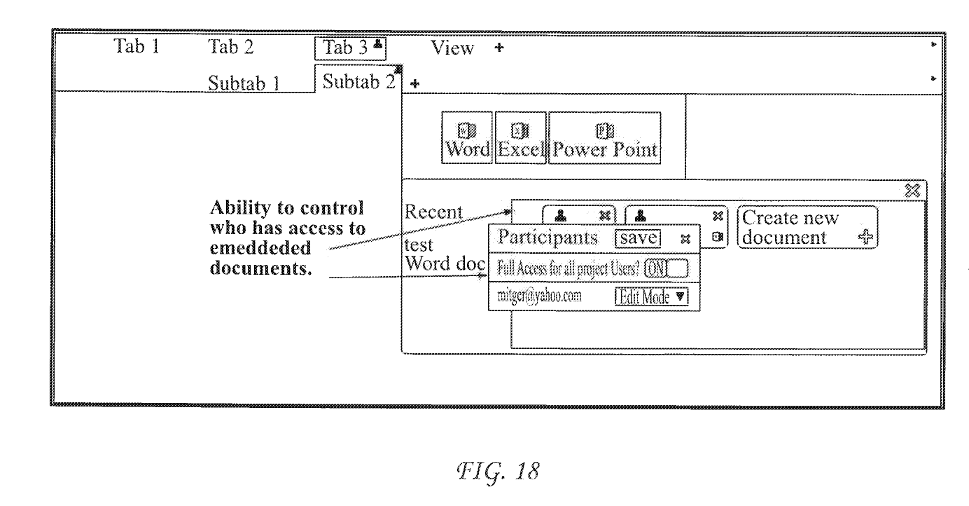

Referring to FIG. 18, the present invention provides the capability to permit or control specific collaborating participants to access, edit and/or “see” certain shared parts of a document or project.

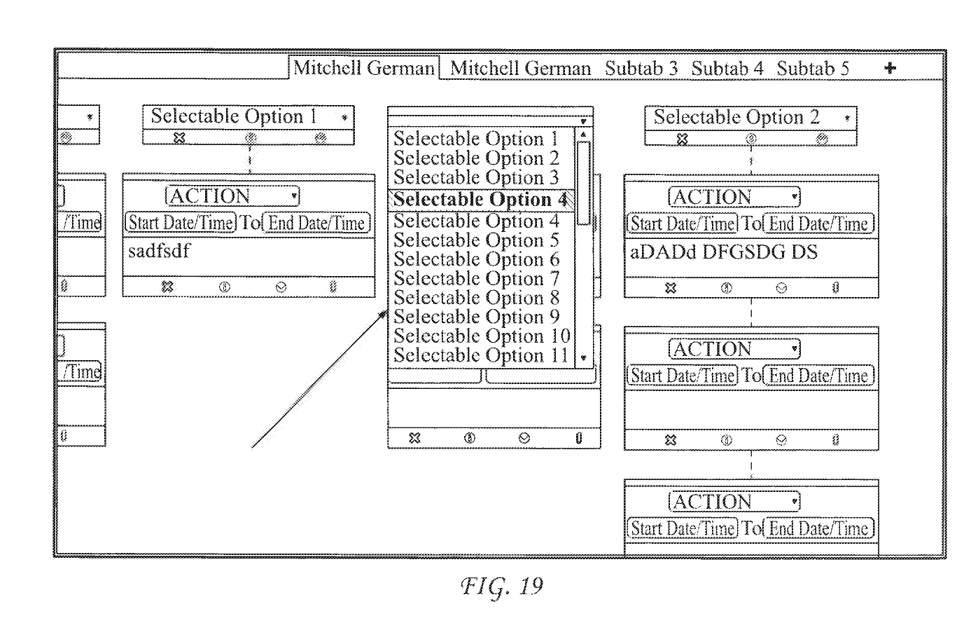

Referring to FIG. 19, the present invention provides the capability to customize Title Bubbles for specific uses via drop down menus.

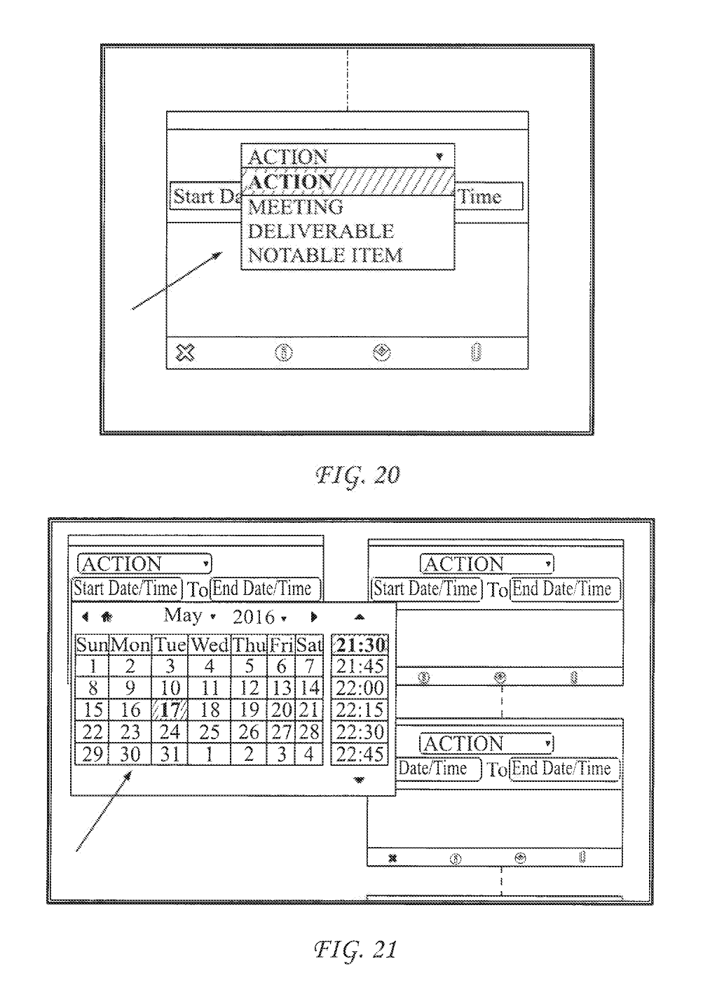

Referring to FIG. 20, the present invention provides the capability to customize Note Bubbles for specific uses via drop down menus.

Referring to FIG. 21, the present invention provides the capability to organize Title and Note Bubbles by Sub Tabs, which can be customized for specific uses via drop down menus.

The present invention provides the capability to organize Sub Tabs, Title Bubbles and Note Bubbles by Tabs, which can be customized for specific uses via drop down menus.

The present invention provides the capability to put a date/time/collaborator stamp on a Note Bubble or Title Bubble.

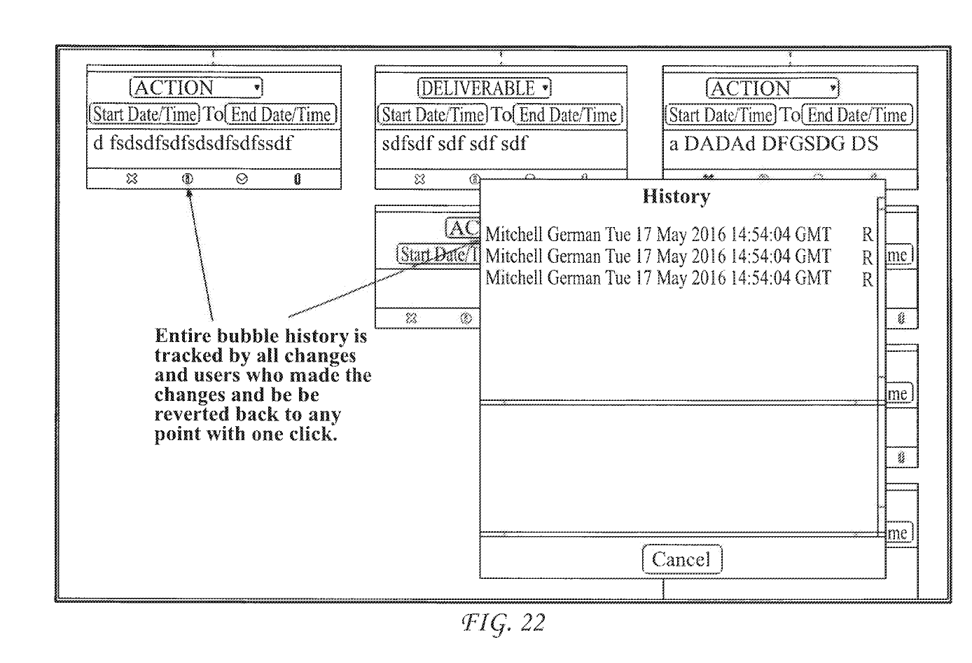

Referring to FIG. 22, the present invention provides the capability to show the history of creation and revisions of Title and Note Bubbles including the person making the changes and the date/time stamp.

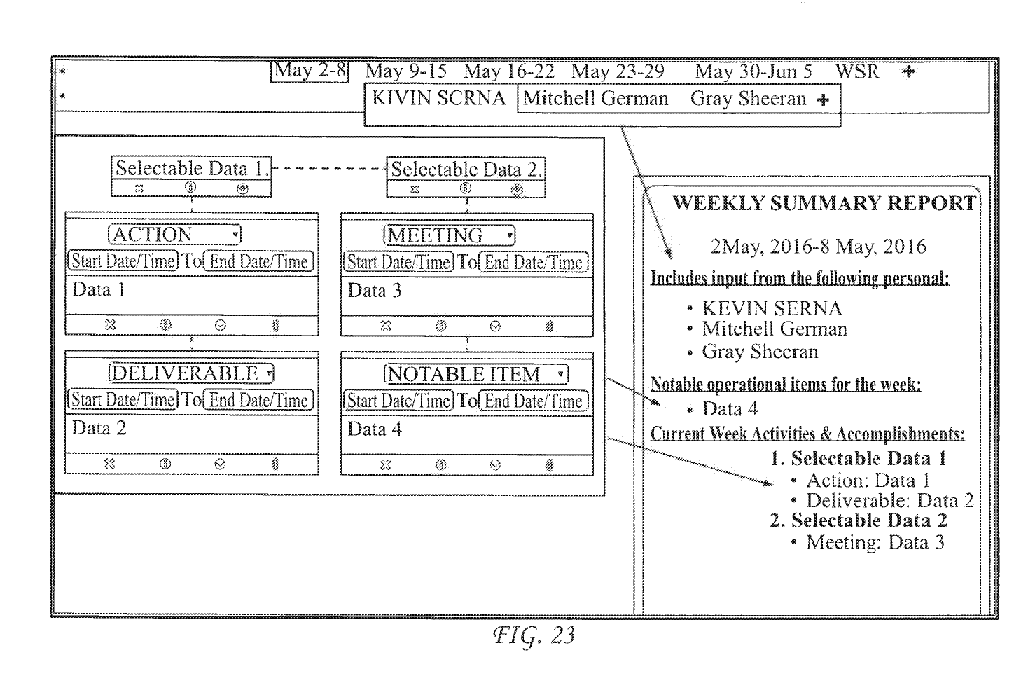

Referring to FIG. 23, the present invention provides the capability to export Tabs, Sub Tabs, Title Bubbles and Note Bubbles to populate a specific customized template or document.

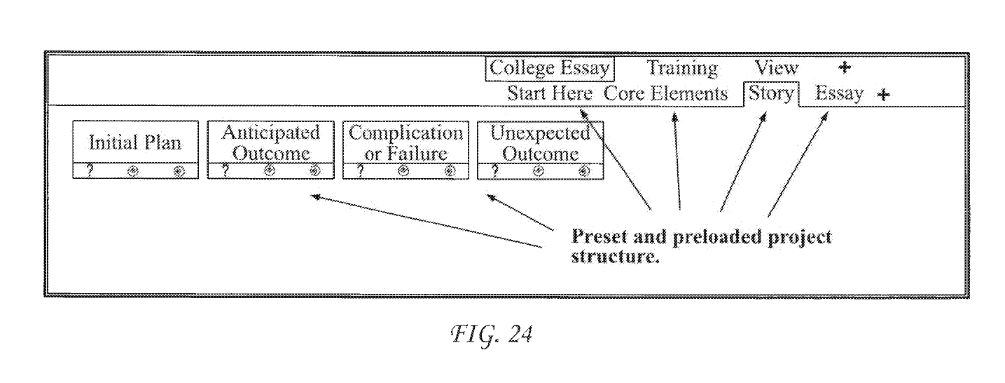

Referring to FIG. 24, the present invention provides the capability to use a pre-designed Template from a Web-based applications provider, commonly referred to as an “app store,” to create the architecture of Tabs, Sub Tabs, Title Bubbles and Note Bubbles associated with that Template, and then migrating Tabs, Sub-Tabs, Title Bubbles and Note Bubbles to the original Template to create the desired project management structure that is suited to the nature of the project being worked on (i.e. Template structure creates Tab/Sub Tab/Title Bubble/Note Bubble structure).

The present invention provides the capability to use an organized set of Tabs, Sub Tabs, Title Bubbles and Note Bubbles available from an App Store and then migrate them into an organized structure within the project managed using the present invention that is exported into and populates an associated Template to create the desired document (i.e. templates can be created from the Tab/Sub Tab/Title Bubble/Note Bubble structure created for a specific project).

The present invention provides the capability for the Tab/Sub Tab/Title Bubble/Note Bubble data of one project or document to be migrated to and populate a different but related project or document.

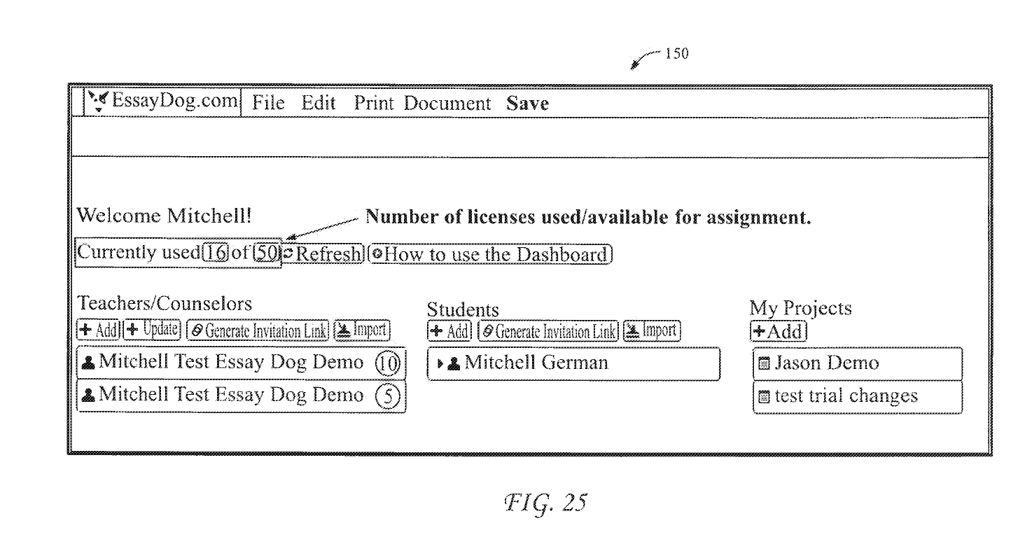

Referring to FIG. 25, an organization can assign an “administrator” who is able to control access to the software by assigning and/or designating others to assign a block of licenses.

The administrator can either assign the licenses directly to individual users or the administrator can designate other “sub-administrators” and assign them a sub-block of licenses based on the number user accounts/licenses that are available to them, and then that sub-administrator can assign that block of license to other end users.

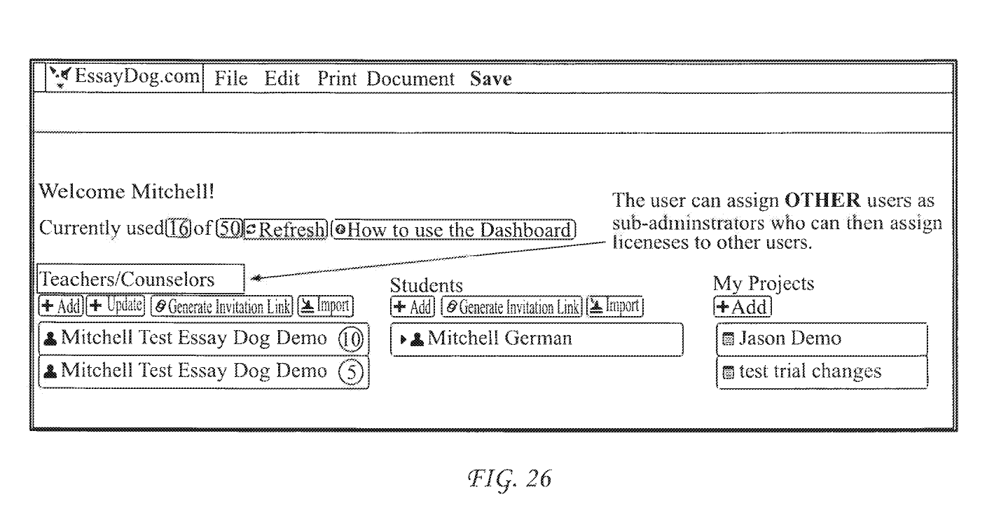

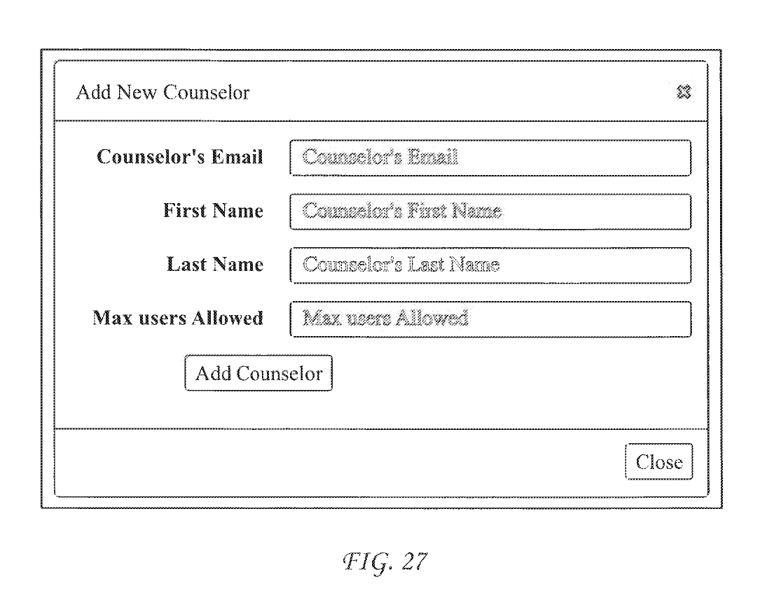

Referring to FIGS. 26 and 27, the administrator can assign other users as “sub-administrators,” who in turn can assign OTHER users licenses or accounts within the software.

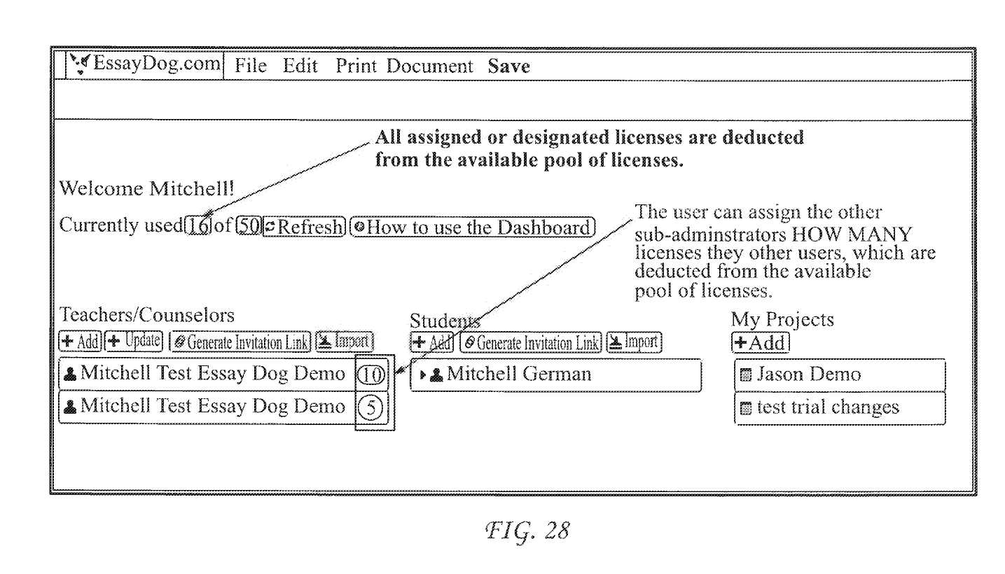

Referring to FIG. 28, the administrator can assign sub-administrators a designated number of licenses that the designated sub-administrator can then assign to other software users.

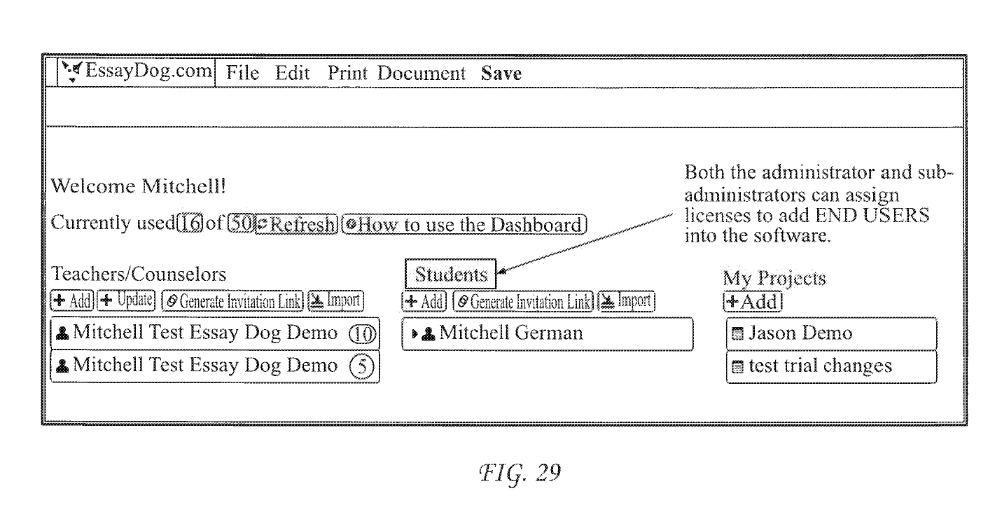

Referring to FIG. 29, both the administrator and sub-administrators can assign licenses and add users into the software based on the total number of license that are available to them. An administrator has all unassigned/designated licenses available to them, whereas a sub-administrator has only the number of designated licenses available to them.

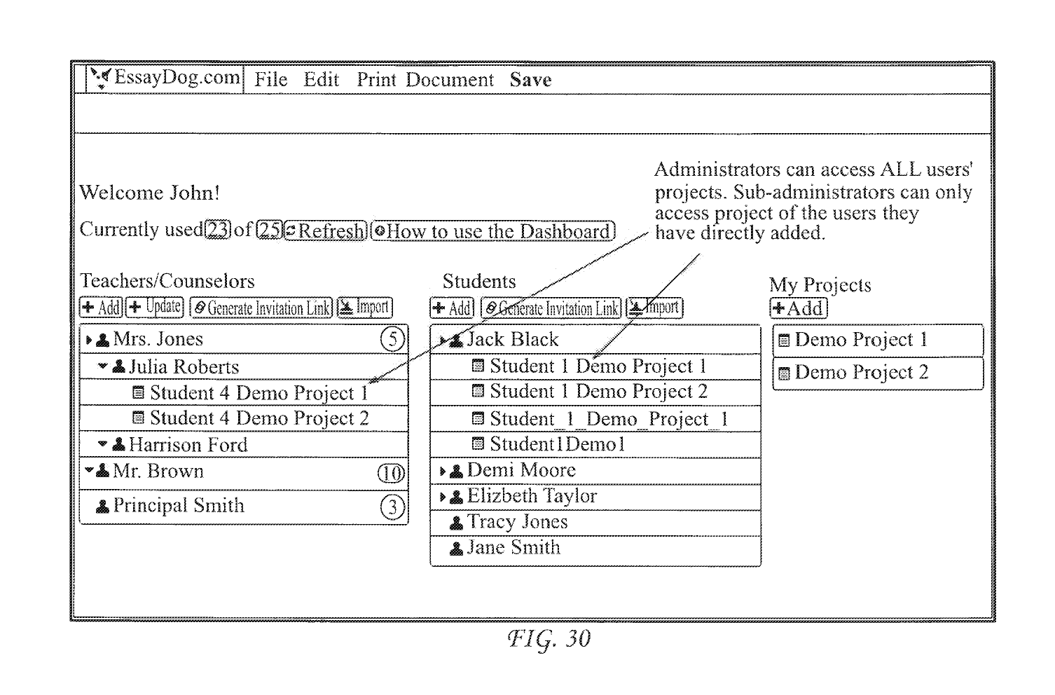

Referring to FIG. 30, from the same screen, an administrator can see every user that has been added, either directly by them or by a sub-administrator. Additionally, the administrator can see EVERY project that all the users have created AND they can access the project directly from the same screen. Sub-Administrators have the same functions, except they are limited to only the users they have directly added.

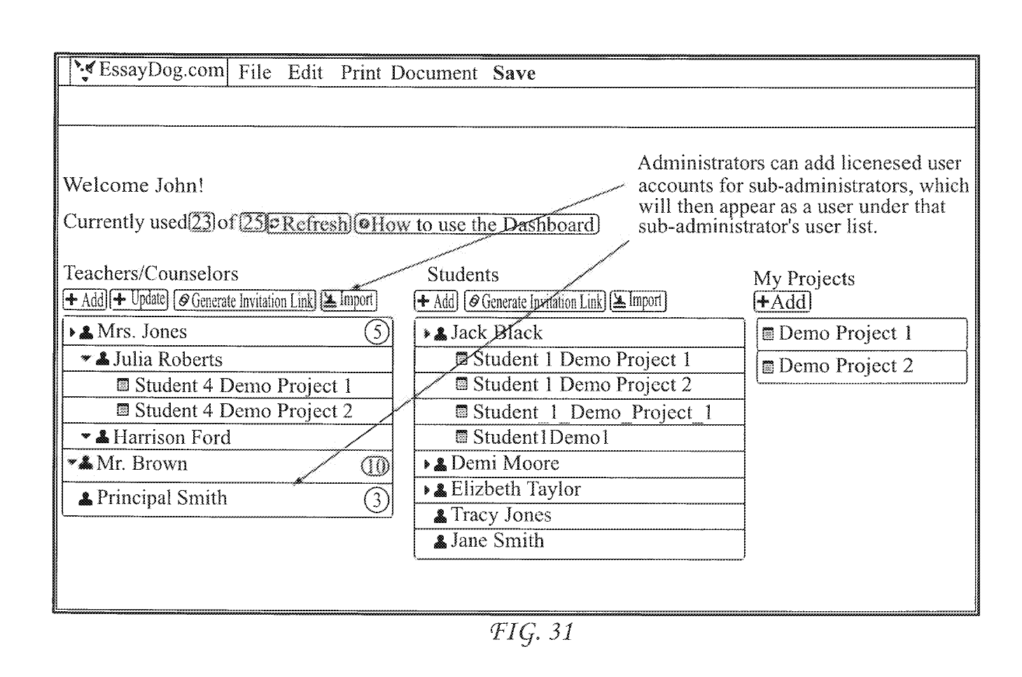

Referring to FIG. 31, the administrator can assign users directly for sub-administrators, eliminating the need for the sub-administrator to add their own users. Users added by the administrator for the sub-administrator appear in the sub-administrator's account.

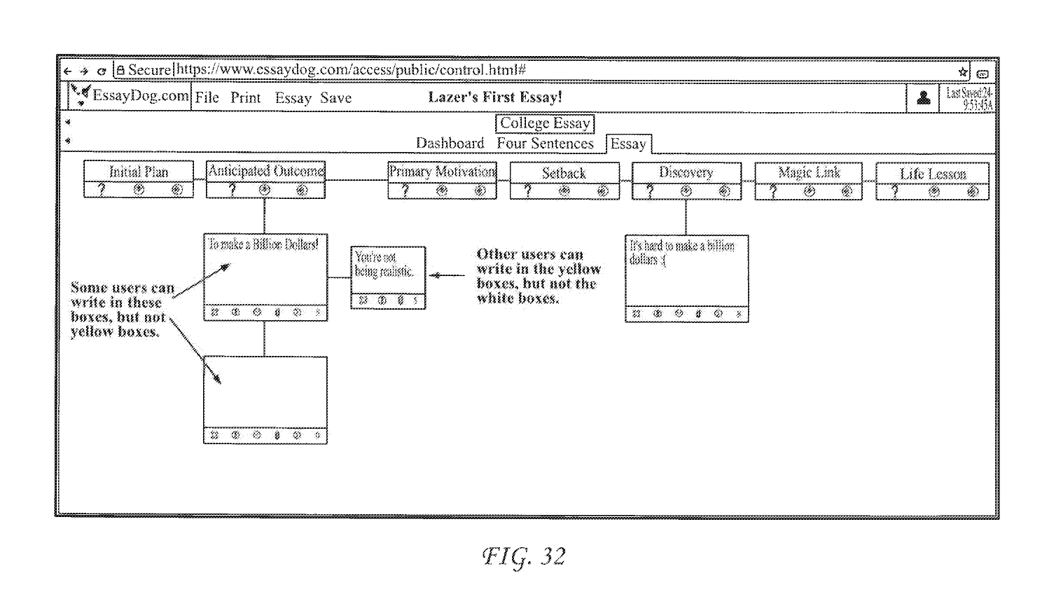

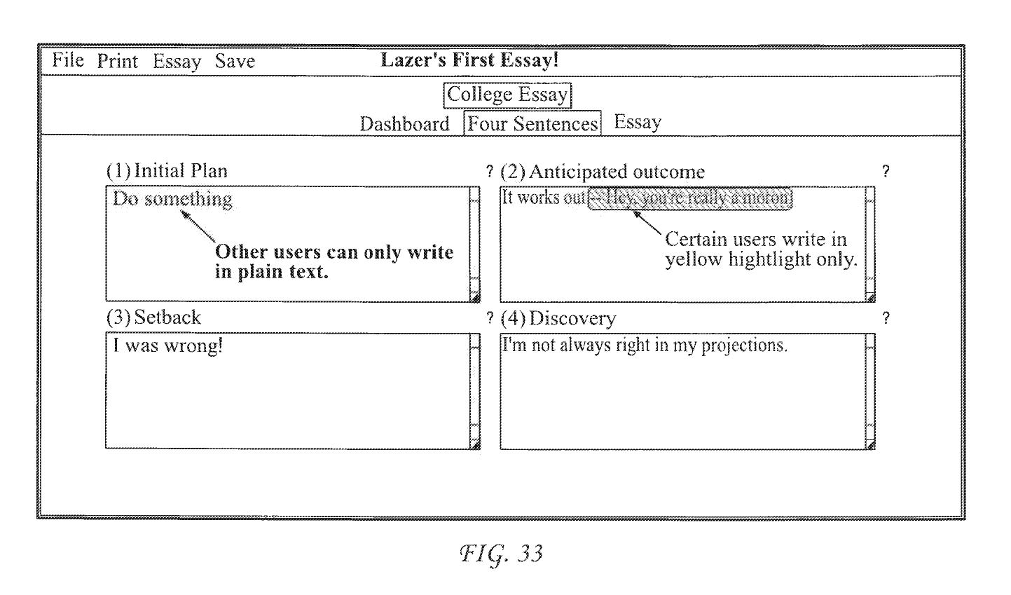

Referring to FIGS. 32 and 33, inside a project, administrators, sub-administrators and other types of users have different roles. The specific user type dictates exactly what parts of the project the user can work with.

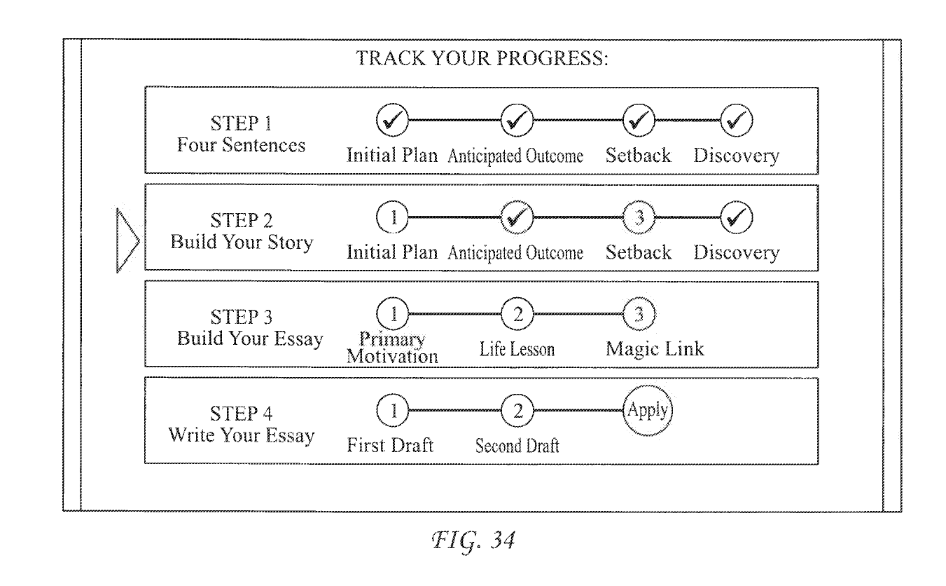

Referring to FIG. 34, the software automatically tracks progress of completed tasks in each individual project and reports it to all of the relevant users.

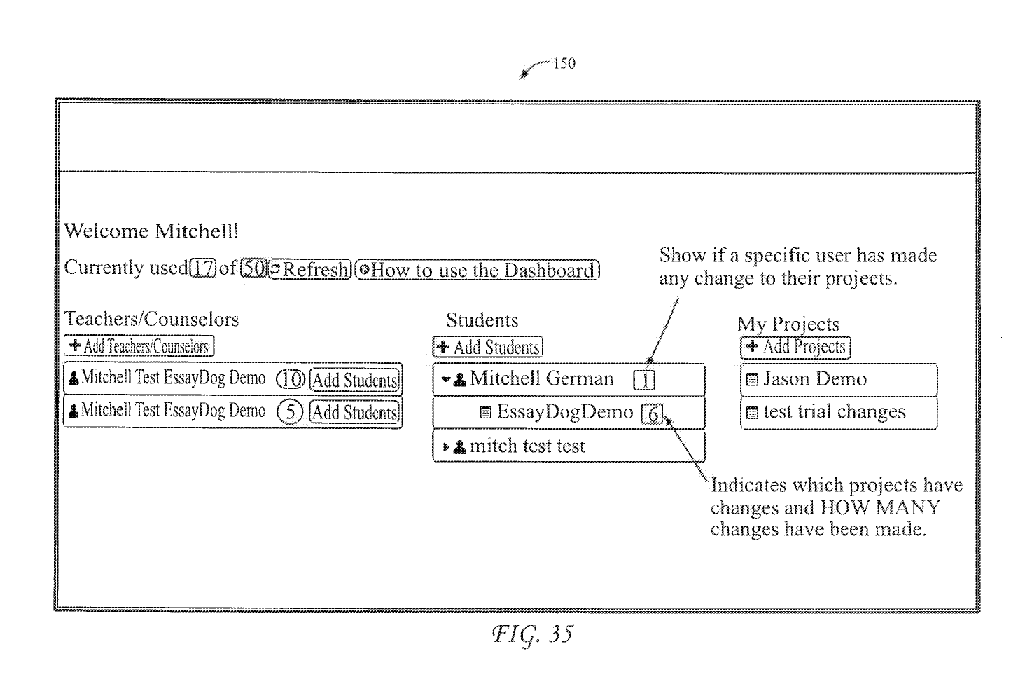

Referring to FIG. 35, from the dashboard, administrators and sub-administrators can see which projects have changed since they last accessed them, and HOW MANY changes have been made.

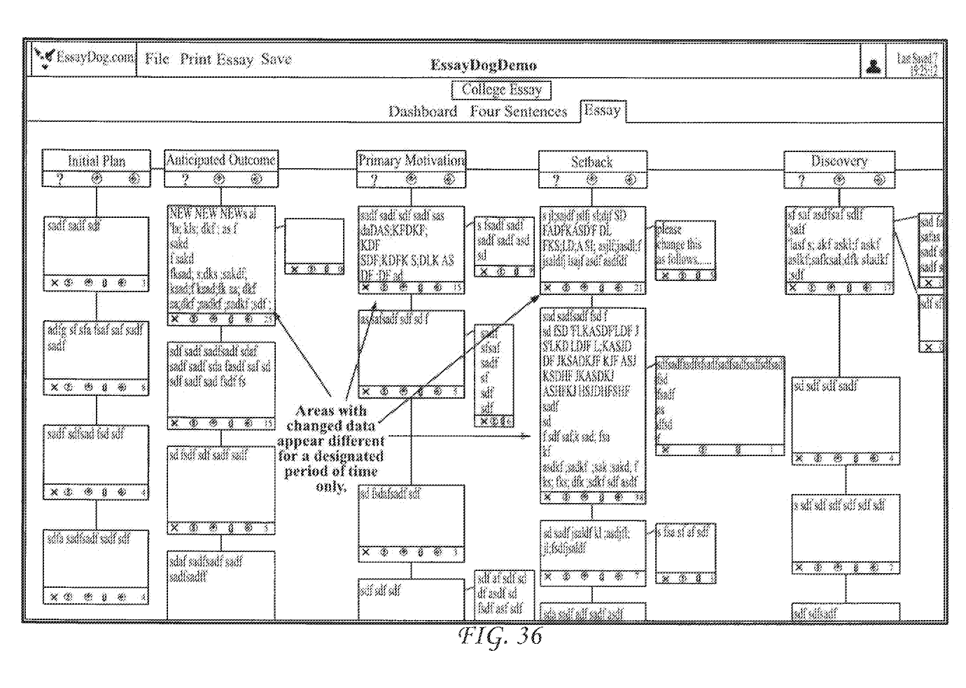

Referring to FIG. 36, inside a project, i.e. project screen, the various users can see relevant changes that apply to them.

It should be understood that the present invention is not limited to the specific embodiments described above, but includes any and all embodiments within the scope of the appended claims.

1. A method for managing projects carried out by one or more participants using a computer system and at least one application program, the computer system including at least one display, at least one processor, input means, and data storage means, the method comprising the steps of:
providing a control program for performing the method in the data storage means;
maintaining for each participant an individual project space in the data storage means, wherein the participant's project space includes data identifying projects that the participant is authorized to participate in and project files or links to project files each corresponding to a respective one of the identified projects, wherein each project file includes project data for the corresponding project;
presenting a saved projects screen to the participant using the display when the control program is prompted to present saved projects by the participant using the input means, wherein the saved projects screen presents an array or list of saved project objects each corresponding to and uniquely identifying a respective one of the projects for which the participant is an authorized participant;
presenting a project screen to the participant using the display when the control program is prompted by the participant to allow access to the project file for a specific project, selected from the projects for which a saved project object appears on the saved projects screen, identified to the control program by the participant using the input means and the corresponding saved project object on the saved projects screen or when the control program is prompted by the participant to create a new project and a corresponding new project file, which is a logical manifestation of the new project, wherein the project screen being presented constitutes an open project screen and the corresponding project file and project constitute an open project file and an open project, respectively;
providing within the project screen one or more tabs each corresponding to a user defined project element associated with the project, wherein one of the tabs is highlighted either by default or as selected by the participant;
providing within the project screen one or more sub-tabs each corresponding to a user defined sub-element associated with the project element corresponding to the highlighted tab, wherein one of the sub-tabs is highlighted either by default or as selected by the participant;
providing within the project screen one or more title bubbles each corresponding to a user defined subject associated with the sub-element corresponding to the highlighted sub-tab;
providing within each title bubble an add title bubble button that can be actuated by the participant using the input means to add a new title bubble to the project screen;
providing within each title bubble an add note button that can be actuated by the participant to add and associate a note bubble on the project screen with the title bubble corresponding to the actuated add note button, wherein each note bubble has a text field for entering and displaying text;
maintaining a database of application files that are recognizable and modifiable by the application program and that are associated with the open project as indicated by the database being maintained within the open project file or being identified within the project file;
launching the application program in response to an input from the participant under the direction of the control program and opening a new or saved application file associated with the open project for modification by the participant; and
adding the new application file, if any, to the database of application files that are associated with the open project.

2. The method of claim 1, wherein a respective database of associated application files is maintained for each project of each participant.

3. The method of claim 1, wherein the database of associated application files contains file names and paths for each of the associated application files.

4. The method of claim 1, further comprising the step of displaying a view tab in addition to the one or more tabs corresponding to project elements, wherein the view tab can be selected to choose between one or more ways to display the tab, sub-tab, title bubble, and note bubble data.

5. The method of claim 1, further comprising the steps of:
displaying within each note bubble an add sub-note button that can be actuated by the participant to add and associate a sub-note bubble with the note bubble corresponding to the actuated add sub-note button, wherein each sub-note bubble has a text field for entering and displaying text; and
displaying the sub-note bubble on the project screen.

6. The method of claim 1, wherein the at least one application program comprises a plurality of application programs needed to complete the open project, the method further comprising the steps of:
providing an application program space on the project screen;
displaying a plurality of icons in the application program space, each icon corresponding to a respective one of the plurality of application programs; and
displaying an application file window showing a list of application files of a type corresponding to a selected one of the plurality of application programs and associated with the open project, wherein the selected one of the plurality of application programs is selected by the participant by selecting the corresponding application program icon.

7. The method of claim 6, further comprising the steps of displaying an add application file button in the application file window, which can be selected by the participant to open a new application file of the type corresponding to the selected one of the plurality of application programs, wherein the new application file will be added to the list of application files displayed in the application file window once the new application file is saved.

8. The method of claim 7, wherein the new application file is also added to the database of application files that are associated with the open project once the new application file is saved and wherein the database of application files is structured so as to allow identification of the application program corresponding to each application file in the database of application files.

9. The method of claim 6, wherein at least one selected field within one of the application files can be linked with a respective note bubble such that when corresponding data in one of the at least one selected field within one of the application files and the respective note bubble is modified then the corresponding data in the other one of the at least one selected field within one of the application files and the respective note bubble is also modified in the same way.

10. The method of claim 6, wherein a selected field within one of the application files can be linked with a respective field in another application file and with a respective note bubble such that when corresponding data in one of these is modified then the corresponding data in all the others are also modified in the same way.

11. The method of claim 1, further comprising the steps of displaying an add tab button on the project screen, which can be selected by the participant to add a new tab to the one or more tabs corresponding to project elements on the project screen.

12. The method of claim 1, further comprising the steps of displaying an add sub-tab button on the project screen, which can be selected by the participant to add a new sub-tab to the one or more sub-tabs corresponding to the highlighted tab on the project screen.

13. A method of claim 1, wherein the participant can edit the label of a tab corresponding to a project element so that the label of the tab is indicative of the corresponding project element, wherein the participant can edit the label of a sub-tab corresponding to a sub-element so that the label of the sub-tab is indicative of the corresponding sub-element, and wherein the participant can edit the label of a title bubble so that the label of the title bubble is indicative of the corresponding subject.

14. The method of claim 1, wherein the at least one application program is a word processing program, wherein the project is directed to the preparation of a project document, the method further comprising the steps of:
displaying a view tab in addition to the one or more tabs corresponding to project elements, wherein the view tab can be selected to choose between one or more ways to display the tab, sub-tab, title bubble, and note bubble data comprising at least an outline mode wherein an outline of the tab, sub-tab, title bubble, and note bubble data is displayed on the project screen in place of the sub-tabs, title bubbles, and note bubbles and a document mode wherein the project document is displayed on the project screen in place of the sub-tabs, title bubbles, and note bubbles.

15. The method of claim 14, wherein a portion of the text in the project document can be linked to a selected note bubble.

16. The method of claim 1, wherein there are a plurality of participants and the participants can be individually assigned a status selected from administrator, sub-administrator, and user, wherein the administrator may designate one or more sub-administrators, wherein user's access to the software is controlled by the grant of licenses, and wherein the administrator has the authority to assign licenses to users and to designate blocks of licenses to be assigned to other end users by a sub-administrator chosen by the administrator.

17. The method of claim 16, further comprising the step of displaying a dashboard from which the administrator or sub-administrators can monitor the activities of other users and the progress of projects.

18. The method of claim 1, wherein there are a plurality of participants and different participants have different privilege levels and have access to different subsets of projects, application programs, application files, tabs, sub-tabs, title bubbles, note bubbles, sub-note bubbles, and related actions or program features in accordance with their privilege level.

19. The method of claim 1, further comprising the steps of:
monitoring the progress of the open project; and
generating a progress report showing which project related tasks have been completed and which project related tasks have yet to be completed.

20. A computer system for carrying out the method of claim 1, the computer system including at least one display, at least one processor, input means, and data storage means.

21. The computer system according to claim 20, wherein the computer system is a networked computer system comprising:
a plurality of client computer systems each comprising a client computer display, a client computer processor, client computer input means, and client computer data storage means; and
a server communicating with said plurality of client computer systems over a network, said server comprising at least a server computer processor and server computer data storage means, wherein the control program is at least stored in said server computer data storage means.

22. A method for preparing a document using a computer system and a word processing program, the computer system including at least one display, at least one processor, input means, and data storage means, the method comprising the steps of:
providing a control program for performing the method in the data storage means;
maintaining for each participant an individual project space in the data storage means, wherein the participant's project space includes data identifying projects that the participant is authorized to participate in and project files or links to project files each corresponding to a respective one of the identified projects, wherein each project file includes project data for the corresponding project;
presenting a project screen to the participant using the display when the control program is prompted by the participant to allow access to the project file for a specific project, selected from the project files saved or identified in the participant's project space by the participant using the input means or when the control program is prompted by the participant to create a new project and a corresponding new project file, which is a logical manifestation of the new project, wherein the project screen being presented constitutes an open project screen and the corresponding project file and project constitute an open project file and an open project, respectively;
displaying within the project screen one tab labeled with the project title;
displaying within the project screen three sub-tabs labeled dashboard, four sentences, and essay, respectively;
displaying under the essay sub-tab when selected title bubbles, note bubbles, and sub-note bubbles that correspond in structure to the outline of a document linked at least to the note bubbles and sub-note bubbles, wherein the document can be accessed and edited through the project screen or through links with at least the note bubbles;
displaying under the four sentences sub-tab four bubbles each with a field for entry of text and labeled initial plan, anticipated outcome, setback, and discovery, respectively; and
displaying under the dashboard sub-tab a tree structure showing the participant's projects and the projects of other participants that the participant is authorized to view, each branch of the tree structure being provided with a toggle button to expand or hide branches that follow from each branch.
